(19) United States
(12) Patent Application Publication
(10) Pub. No.: US 2026/0148216 A1
(43) Pub. Date: May 28, 2026

(54) SALES DATA PROCESSING DEVICE, CONTROL METHOD, AND RECORDING MEDIUM

(71) Applicant: NEC Corporation, Tokyo (JP)

(72) Inventor: Hideo Urai, Tokyo (JP)

(73) Assignee: NEC Corporation, Tokyo (JP)

(21) Appl. No.: 19/361,330

(22) Filed: Oct. 17, 2025

(30) Foreign Application Priority Data
Nov. 26, 2024 (JP) 2024-205714

(51) Int. Cl. G06Q 20/20

(52) U.S. Cl. CPC G06Q 20/208

(57) ABSTRACT

A sales data processing device of the present disclosure includes a memory storing instructions, and a processor configured to execute the instructions to: determine to operate a salesclerk checkout mode or a customer checkout mode, the salesclerk checkout mode being a mode for processing checkout for a product registered by a salesclerk, and the customer checkout mode being a mode for processing checkout by settlement on the sales data processing device for a product registered by a customer on the sales data processing device or a product registered by a salesclerk on another device, register a product to be purchased by the customer, configure, in a case of operating the salesclerk checkout mode, whether to perform settlement on the sales data processing device or to output the checkout information for performing settlement on another device, and process checkout according to the mode determined and the configuration.

This application is based upon and claims the benefit of priority from Japanese patent application No. 2024-205714, filed on November 26, 2024, the disclosure of which is incorporated herein in its entirety by reference.

### TECHNICAL FIELD

The present disclosure relates to a sales data processing device and the like.

### BACKGROUND ART

In a retail store, introduction has been studied of a multifunction register capable of handling a plurality of sales methods with one sales data processing device. A sales data processing device of JP 2019-153126 A switches between a mode in which a customer performs product registration and performs settlement and a mode in which a salesclerk performs product registration and the customer performs settlement. In JP 2019-153126 A, switching is performed between a mode in which product registration is performed on the salesclerk side and settlement is performed on the customer side of one sales data processing device, and a mode in which product registration is performed on the salesclerk side of a sales data processing device and settlement is performed on the customer side of another sales data processing device.

### SUMMARY

An object of the present disclosure is to provide a sales data processing device and the like in which operation switching is easy in a case where settlement can be performed on a device different from a device on which product registration is performed.

A sales data processing device according to one aspect of the present disclosure includes at least one memory storing instructions; and at least one processor configured to execute the instructions to: determine to operate the sales data processing device in a salesclerk checkout mode or a customer checkout mode, the salesclerk checkout mode being a mode for processing a checkout operation in response to an operation by a salesclerk for a product registered by the salesclerk on the sales data processing device, the checkout operation being processed by settlement on the sales data processing device or by outputting checkout information for performing settlement on another device, and the customer checkout mode being a mode for processing a checkout operation in response to an operation by a customer for at least one of a product registered by the customer on the sales data processing device or a product registered by a salesclerk on another device, the checkout operation being processed by settlement on the sales data processing device; register a product to be purchased by the customer; configure, in a case of operating the salesclerk checkout mode, whether to perform settlement on the sales data processing device or to output the checkout information for performing settlement on another device; and process checkout according to the mode determined and the configuration.

A control method according to one aspect of the present disclosure includes determining to operate a sales data processing device in a salesclerk checkout mode or a customer checkout mode, the salesclerk checkout mode being a mode for processing a checkout operation in response to an operation by a salesclerk for a product registered by the salesclerk on the sales data processing device, the checkout operation being processed by settlement on the sales data processing device or by outputting checkout information for performing settlement on another device, and the customer checkout mode being a mode for processing a checkout operation in response to an operation by a customer for at least one of a product registered by the customer on the sales data processing device or a product registered by a salesclerk on another device, the checkout operation being processed by settlement on the sales data processing device; configuring, in a case of operating the salesclerk checkout mode, whether to perform settlement on the sales data processing device or to output the checkout information for performing settlement on another device; and processing checkout according to the mode determined and the configuration.

A non-transitory computer-readable recording medium according to one aspect of the present disclosure stores a program for causing a computer to execute processing including: determining to operate a sales data processing device in a salesclerk checkout mode or a customer checkout mode, the salesclerk checkout mode being a mode for processing a checkout operation in response to an operation by a salesclerk for a product registered by the salesclerk on the sales data processing device, the checkout operation being processed by settlement on the sales data processing device or by outputting checkout information for performing settlement on another device, and the customer checkout mode being a mode for processing a checkout operation in response to an operation by a customer for at least one of a product registered by the customer on the sales data processing device or a product registered by a salesclerk on another device, the checkout operation being processed by settlement on the sales data processing device; configuring, in a case of operating the salesclerk checkout mode, whether to perform settlement on the sales data processing device or to output the checkout information for performing settlement on another device; and processing checkout according to the mode determined and the configuration.

### BRIEF DESCRIPTION OF THE DRAWINGS

Exemplary features and advantages of the present disclosure will become apparent from the following detailed description when taken with the accompanying drawings in which:

FIG. 1 is an explanatory diagram illustrating an example of connection between a POS terminal and another device;

FIG. 2 is an explanatory diagram illustrating an arrangement example of POS terminals;

FIG. 3 is a block diagram illustrating a configuration example of the POS terminal;

FIG. 4 is a flowchart illustrating an operation example of the POS terminal;

FIG. 5 is a diagram illustrating an example of a salesclerk code input screen;

FIG. 6 is a diagram illustrating an example of a mode selection screen;

FIG. 7 is a diagram illustrating an example of a product registration screen for salesclerks;

FIG. 8 is a diagram illustrating an example of the product registration screen for salesclerks;

FIG. 9 is a diagram illustrating an example of the product registration screen for salesclerks;

FIG. 10 is a diagram illustrating an example of a payment screen for salesclerks;

FIG. 11 is a diagram illustrating an example of a product registration screen for customers;

FIG. 12 is a diagram illustrating an example of the product registration screen for customers;

FIG. 13 is a diagram illustrating an example of a payment method selection screen for customers;

FIG. 14 is a block diagram illustrating a configuration example of a POS terminal;

FIG. 15 is a flowchart illustrating an operation example of the POS terminal; and

FIG. 16 is a block diagram illustrating an example of a hardware configuration of a computer.

### EXAMPLE EMBODIMENT

### First Example Embodiment

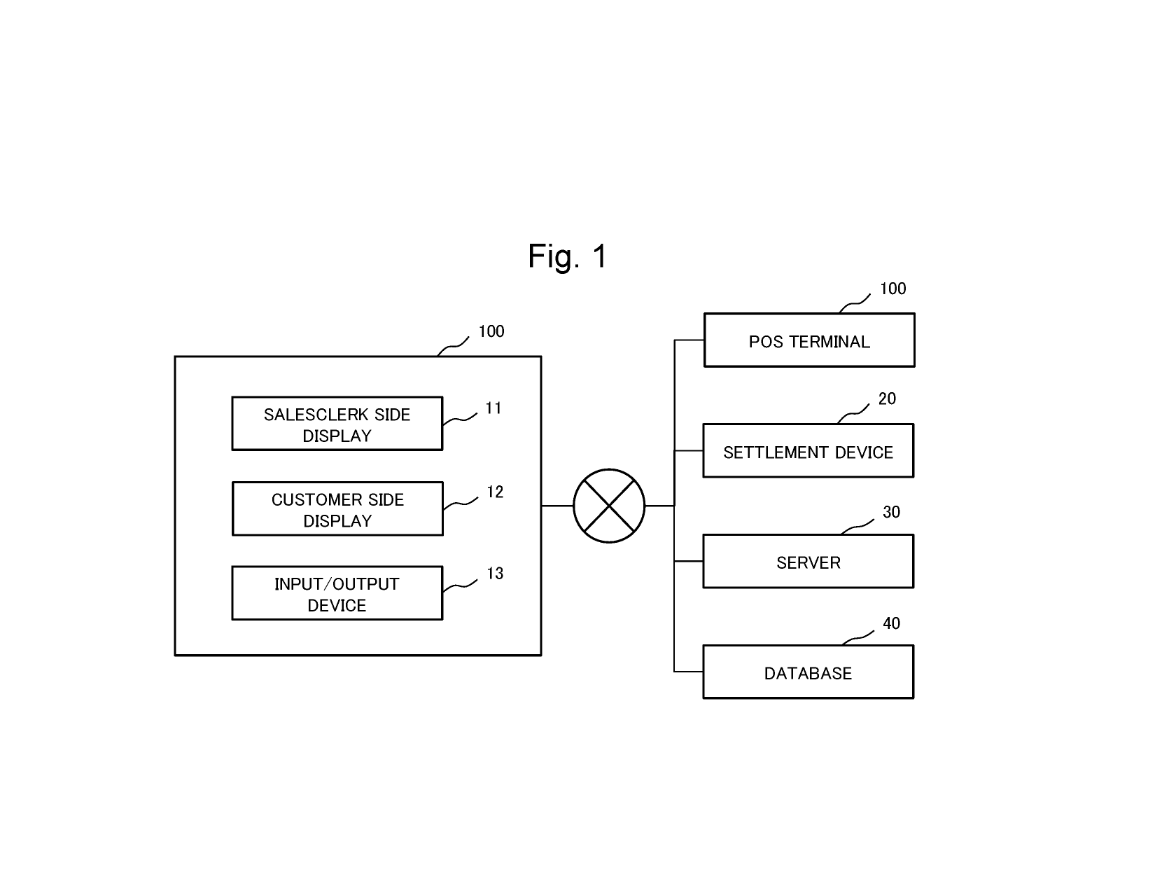

With reference to FIG. 1, an example will be described of connection between a Point of Sales (POS) terminal 100 and another device in the present disclosure. The POS terminal 100 is communicably connected to another POS terminal 100, a settlement device 20, a server 30, and a database 40 via a communication network. The communication network is, for example, an in-store network. The communication network enables data sharing between devices and centralized management of the devices by the server 30.

In one example, the POS terminal 100 is configured as a two-screen POS terminal, and includes a salesclerk side display 11, a customer side display 12, and various input/output devices 13. The salesclerk side display 11 and the customer side display 12 each are, for example, a touch panel type display that displays various types of information and receives input by touch operation. As the input/output devices 13, for example, a code scanner, a button-type operation panel, and a receipt printer may be adopted. The POS terminal 100 is one example embodiment of a sales data processing device.

The POS terminal 100 may be configured as a one-screen POS terminal in which the orientation of the screen is switchable. In this case, the salesclerk side display 11 and the customer side display 12 are implemented by one display. The display caused to face a salesclerk side functions as the salesclerk side display 11, and the display caused to face a customer side functions as the customer side display 12.

The POS terminal 100 has functions of product registration, settlement on the POS terminal 100, and checkout information output for settlement on another device. On the POS terminal 100, these functions can be switched and used. The POS terminal 100 may be switchable between operation of product registration by a salesclerk and operation of product registration by a customer. A plurality of the POS terminals 100 may be provided in the store. In a case where another registration device other than the POS terminal 100 is available in the store, the number of the POS terminals 100 disposed in the store may be one. The another registration device is, for example, a smartphone of the customer, a smartphone or a tablet of the store, or a portable terminal for pre-handling of the store.

The POS terminal 100 is connected to at least one of, for example, a cash drawer, an automatic change machine, an electronic money settlement terminal, a credit card settlement terminal, and the like for the settlement on the POS terminal 100. These settlement means may be configured integrally with a device that implements the POS terminal 100, or may be implemented by a device different from the POS terminal 100. In a case where the automatic change machine is installed to face the customer side, even in a case where the salesclerk performs product registration, the customer can put in cash and receive change by oneself. The POS terminal 100 can perform settlement processing by a payment method selected by the customer. Operation of selecting the payment method may be performed by the salesclerk or the customer. The POS terminal 100 includes a receipt printer as one of the input/output devices 13, and may cause a checkout slip code to be printed. The checkout slip code is output in the form of a one-dimensional code or a two-dimensional code. Another device is caused to read the checkout slip code, whereby settlement can be performed on the another device.

The settlement device 20 functions as a dedicated settlement machine. The settlement device 20 reads the checkout slip code and receives checkout information associated with the checkout slip code. Then, settlement processing is performed based on the received checkout information. The settlement device 20 is configured as, for example, a one-screen POS terminal. Terminals in various forms, such as a tablet, a smartphone, and a portable settlement terminal of the store, and a smartphone of the customer, can be used as the settlement device 20. The settlement device 20 is provided as necessary.

The server 30 receives the checkout information from the POS terminal 100 or another registration device. The checkout information includes detailed information regarding the transaction, for example, a product code, a product name, a unit price, a quantity, a subtotal, a total amount, a tax amount, and the like. The checkout information is associated with the checkout slip code that is an identifier for uniquely identifying the checkout information. The server 30 instructs the database 40 to store the received checkout information in association with the checkout slip code. The server 30 performs transmission in response to a request from the another POS terminal 100 or the settlement device 20. The server 30 can centrally manage transaction data of all the POS terminals 100 and the settlement device 20 in the store. This enables real-time sales aggregation, inventory management, transaction history tracking, and the like. Since the same checkout information can be accessed by any terminal, the customer can flexibly select a settlement location.

The database 40 stores and manages various types of information, based on an instruction from the server 30. The database 40 manages, for example, product information such as a product code, a product name, a price, and a stock quantity, a transaction history, a table of correspondence between a checkout slip code and checkout information, and employee information. The employee information includes, for example, a salesclerk code for identifying a salesclerk, authorization setting, and the like. The database 40 plays a role of quickly providing necessary information in response to an inquiry from the POS terminal 100 or the settlement device 20. The database 40 also functions as a base for backup and data analysis. The database 40 may be implemented by different hardware for each type of data to be stored.

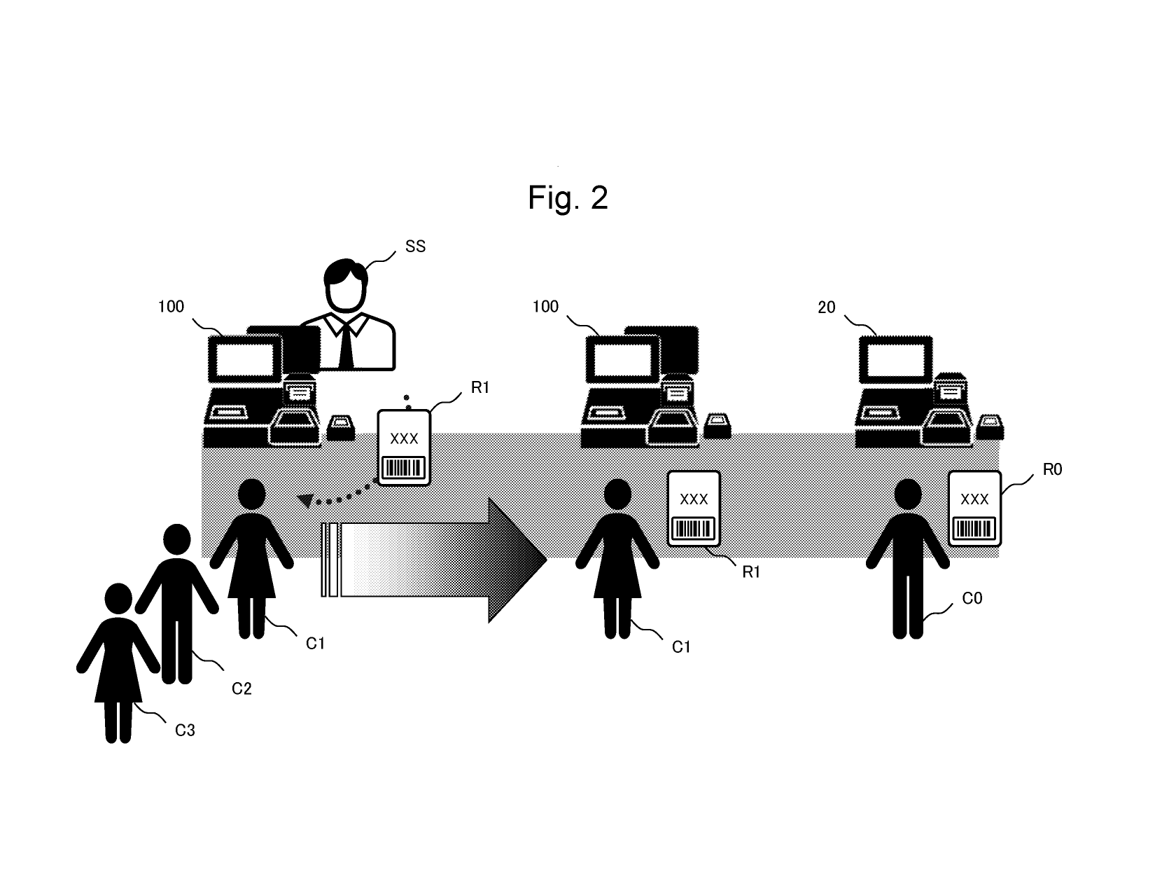

With reference to FIG. 2, an arrangement example will be described of the POS terminals 100 in the store. The POS terminals 100 are installed, for example, on a counter of the store. On the counter, the POS terminals 100 of the same type, and the settlement device 20 configured as a one-screen POS terminal are installed side by side. A salesclerk SS stands on the back side of the counter and operates the POS terminal 100 on the left in the drawing. Then, customers C1, C2, and C3 stand in a line on the opposite side of the counter. The customer C1 at the head receives product registration by the salesclerk. Then, the customer C1 proceeds with settlement by making payment in cash or electronic money. Depending on the aspect of the POS terminal 100, the customers C0 and C1 receive checkout slip codes R0 and R1 from the salesclerk and move laterally (right in the drawing), and perform settlement on another POS terminal 100 and the settlement device 20. Depending on an operating state of the POS terminal 100, it is also possible for the customer C1 to operate the POS terminal 100 in the center of the drawing from the front side of the counter to perform product registration and settlement. The arrangement and configuration of the POS terminals 100 and the settlement device 20 are not limited to the example of FIG. 2. A one-screen POS terminal may be installed as the POS terminal 100. A configuration may be adopted in which some of the POS terminals 100 enable payment in cash, and other POS terminals 100 and the settlement devices 20 do not accept payment in cash.

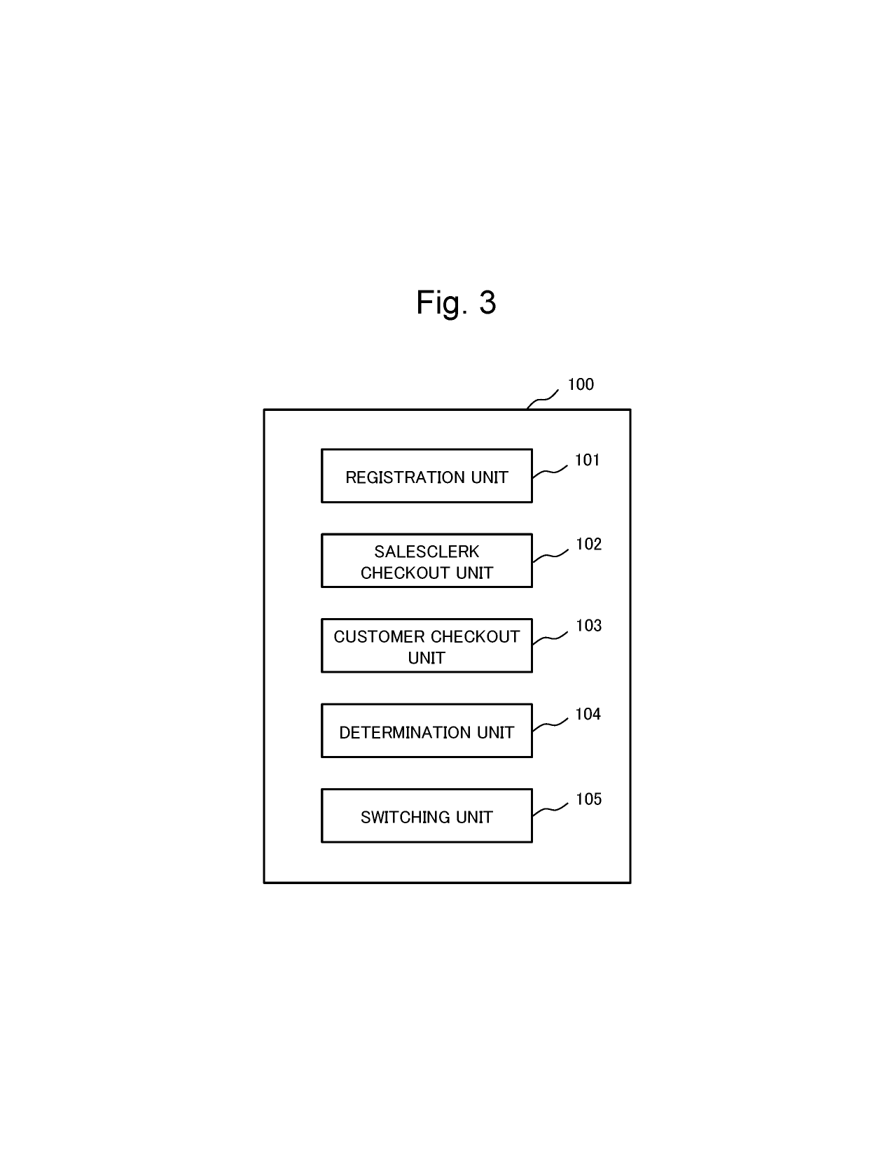

With reference to FIG. 3, a configuration example will be described of the POS terminal 100 in the present disclosure. The POS terminal 100 includes a registration unit 101, a salesclerk checkout unit 102, a customer checkout unit 103, a determination unit 104, and a switching unit 105. Constituent elements are software components in units of functions.

The registration unit 101 registers a product. The registration unit 101 registers, for example, a product whose product code is read by a code scanner or reader as a product to be purchased by the customer. The product code is attached to the product in the form of a one-dimensional code, a two-dimensional code, or an RFID tag. The registration unit 101 may register a product having a product code input on the touch panel or a selected product name. The registration unit 101 may capture an image of a product with an image recognition camera and register the product identified by using an image recognition technology.

In a case where the salesclerk operates the POS terminal 100 when the registration unit 101 registers a product, the salesclerk receives the product from the customer and reads the product code. For a product without a code, the salesclerk operates the touch panel of the salesclerk side display 11 to register the product. On the other hand, in a case where the customer performs the operation, the customer oneself reads the product code as described above. A product without a product code is, for example, selected from options on the screen and registered.

The salesclerk checkout unit 102 processes checkout for the product registered by the salesclerk on the POS terminal 100 in response to the operation by the salesclerk. The salesclerk checkout unit 102 handles both the settlement on the POS terminal 100 and the settlement on another device.

First, a description will be given of checkout processing by the settlement on the POS terminal 100. The salesclerk checkout unit 102 receives payment in cash or electronic money for the product registered by the registration unit 101 of the POS terminal 100, and performs the settlement. After completion of the settlement, the salesclerk checkout unit 102 causes the printer to print a receipt. Accordingly, the checkout processing is completed. The salesclerk hands the printed receipt to the customer.

Next, a description will be given of checkout processing by output of checkout information for performing settlement on another device. In one example, the salesclerk checkout unit 102 transmits the checkout information to the server 30. Then, the salesclerk checkout unit 102 causes the receipt printer to print a checkout slip code. Accordingly, the checkout processing is completed. In response to the fact that the checkout slip code is read by another device, the server 30 transmits corresponding checkout information to the device.

Alternatively, the salesclerk checkout unit 102 may be configured to directly transmit the checkout information to another POS terminal 100 or the settlement device 20. In this case, printing of the checkout slip code may be omitted in the checkout processing. The salesclerk orally notifies the customer of the number of the POS terminal 100 or the settlement device 20 as a transmission destination of the checkout information. The customer moves to another device indicating the number of which the notification is performed, and performs settlement by the customer’s operation. The transmission destination may be determined in advance, or may be selected by the salesclerk performing operation on the salesclerk side display 11.

The customer checkout unit 103 processes checkout for a product registered by the customer on the POS terminal 100 or a product registered by the salesclerk on another device in response to the operation by the customer. Examples of another registration device include another POS terminal 100, a smartphone of the customer, a smartphone and a tablet of the store, and a portable terminal for pre-handling of the store.

A case will be described where the customer checkout unit 103 processes checkout for the product registered by the registration unit 101 by the operation by the customer on the POS terminal 100. In a case where the customer selects that registration of all products is completed on the customer side display 12, the customer checkout unit 103 receives selection of a payment method. Then, the customer checkout unit 103 processes payment by the selected payment method. After completion of the settlement, a receipt is printed, and the customer receives the printed receipt. Accordingly, the checkout processing is completed.

A case will be described where the customer checkout unit 103 processes checkout for the product registered by the registration unit 101 by the operation by the salesclerk on another device. For checkout processing, a printed checkout slip code is read. The checkout slip code is, for example, a code printed by a receipt printer or a code displayed on a smartphone of the customer. The customer checkout unit 103 acquires the checkout information associated with the code from the server 30 in response to the fact that the checkout slip code is read. Settlement is performed similarly to the above case, based on the acquired checkout information. After completion of the settlement, a receipt is printed, and the customer receives the printed receipt. Accordingly, the checkout processing is completed. In a case where the checkout slip code is not used, the POS terminal 100 receives transfer of the checkout information from another device of the store, such as the server 30 or the another POS terminal 100.

The customer checkout unit 103 has a function of at least one of settlement of the product registered by the operation by the customer on the POS terminal 100 and settlement of the product registered by the salesclerk on another device. Reading of the product code and reading of the checkout slip code may be used together. In this case, the checkout slip code is read around the time of reading the product code. Then, the customer checkout unit 103 performs settlement by adding up for products registered by the customer and the salesclerk. In this case, the customer can select “proceed to settlement” or “additional scan of a product” after confirming a product list read with the checkout slip code. In a case where “proceed to settlement” is selected, the customer checkout unit 103 proceeds to payment processing with a current product list. On the other hand, in a case where “additional scan of a product” is selected, the customer can scan and register an additional product.

The determination unit 104 determines to operate either the salesclerk checkout unit 102 or the customer checkout unit 103 of the POS terminal 100. Specifically, for example, determination is made by operation by the salesclerk through a mode switching button on salesclerk side display 11. The determination unit 104 may determine a mode according to a detection result by a human sensor included in the POS terminal 100. For example, in a case where a side where the salesclerk stands and a side where the customer stands are distinguished from each other, when the human sensor detects a person on the salesclerk side, the determination unit 104 determines to operate the salesclerk checkout unit 102. Then, in a case where no person is detected on the salesclerk side, the determination unit 104 determines to operate the customer checkout unit 103.

Specifically, an infrared sensor or a camera can be used as the human sensor. In a case where a camera is used, it is possible to identify the salesclerk or the customer by utilizing a face recognition technology. The human sensor can also recognize movement of the salesclerk. For example, an action of the salesclerk is detected, such as stopping in front of the POS terminal or facing the POS terminal. Furthermore, it is also possible to make a determination by combining conditions such as the salesclerk being in front of the POS terminal for a predetermined time or the salesclerk looking at the POS terminal. Based on these detection results, the determination unit 104 selects an appropriate mode and improves operability of the POS terminal 100.

In a case where the POS terminal 100 is configured as a one-screen POS capable of switching the orientation of the screen, the salesclerk switches the orientation of the screen of the POS terminal 100, whereby it may be enabled to select a mode according to the orientation of the screen. In a case where the screen faces the salesclerk side, the determination unit 104 determines to operate the salesclerk checkout unit 102. In a case where the screen faces the customer side, it is determined to operate the customer checkout unit 103.

In a case where the salesclerk checkout unit 102 is operated, the switching unit 105 performs switching between performing settlement on the POS terminal 100 and outputting the checkout information. The switching unit 105 performs switching between performing settlement on the POS terminal 100 and outputting the checkout information according to operation by the salesclerk. At the time of activation of the POS terminal 100, the salesclerk may perform switching as initial setting. For example, at the time of opening in the morning, based on an operation policy of the store on that day, the settlement on the POS terminal 100 or the output of the checkout information is selected. As a result, a basic operation mode of one day can be set. Next, the salesclerk can perform switching at any timing during business hours. For example, it is possible to flexibly perform switching for each transaction according to a congestion situation of the store or a demand of the customer. Specifically, it is possible to select a settlement method suitable for the transaction by operating a switching button displayed on the salesclerk side display 11 at a timing after completion of product registration or before the start of settlement.

The switching unit 105 may further perform switching between performing settlement on the POS terminal 100 and outputting the checkout information according to operation by the customer. For example, settlement method selection buttons are displayed on the customer side display 12 together with a list of products registered by the salesclerk. In the displayed selection buttons, descriptions are displayed, for example, “checkout here”, “self-checkout on another device”, and the like. In a case where the customer selects “checkout here”, the switching unit 105 switches to a mode for the settlement on the POS terminal 100. On the other hand, when “self-checkout on another device” is selected, the switching unit 105 switches to a mode for outputting the checkout information. In a case where the customer does not perform the selection, a settlement device is selected according to the selection by the salesclerk or the basic operation mode of the POS terminal 100.

The switching unit 105 switches guidance screens to be displayed on the customer side display 12. For example, during product registration by the salesclerk, guidance is displayed as to whether settlement is performed on the spot or on another device. For example, the guidance is displayed together with a list of products registered by the salesclerk. In a case where the settlement on the POS terminal 100 is determined, an example of guidance is a message such as “checkout will be performed on this device”. In a case where the settlement on another device is determined, an example of the guidance is a message such as “checkout will be performed on another device, please receive the checkout slip”. In a case where the settlement is performed on another device, guidance may be displayed as to where the customer should move after completion of product registration. For example, a message is displayed such as “Please perform checkout at the checkout counter number ○.”. In one example, these guidance screens are automatically switched immediately after completion of product registration. With this function, the customer can select an appropriate settlement method without hesitation.

The switching unit 105 may further switch screens to be displayed for the customer in a case where the customer checkout unit 103 is operated. This switching is performed mainly according to the type of code read. For example, in a case where a product code is read, the switching unit 105 displays a product registration screen. After completion of product registration, the product registration screen transitions to a payment method selection screen. On the other hand, in a case where a checkout slip code is read, the switching unit 105 displays a payment method selection screen. The product registration screen may be displayed by pressing of a “return” button on the payment method selection screen. The screens are switched depending on the read code, whereby the customer can smoothly proceed with settlement processing.

However, in a case where the customer checkout unit 103 is operated, depending on the configuration of the POS terminal 100, the screen is not switched, and the same screen may be displayed even if any code is read. For example, in a case where the checkout slip code is read, the product registration screen may be displayed similar to that in a case where the product code is read.

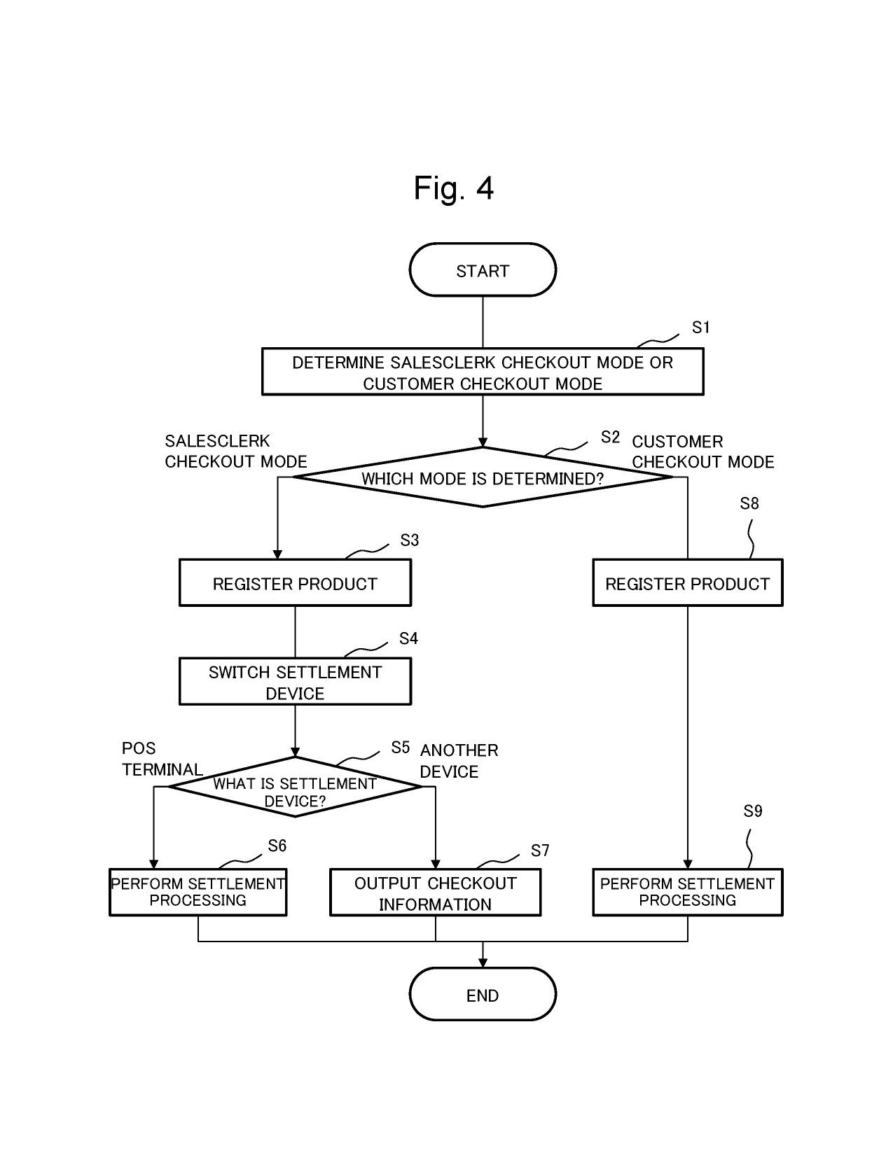

With reference to FIG. 4, an operation example will be described of the POS terminal 100 in the present disclosure. For example, when the POS terminal 100 is activated, the operation of FIG. 4 is started.

In step S1, the determination unit 104 determines to operate the POS terminal 100 in either the salesclerk checkout mode or the customer checkout mode. The salesclerk checkout mode is a mode in which the salesclerk checkout unit 102 operates. The customer checkout mode is a mode in which the customer checkout unit 103 operates. In step S2, it is determined whether the determined mode is the salesclerk checkout mode or the customer checkout mode.

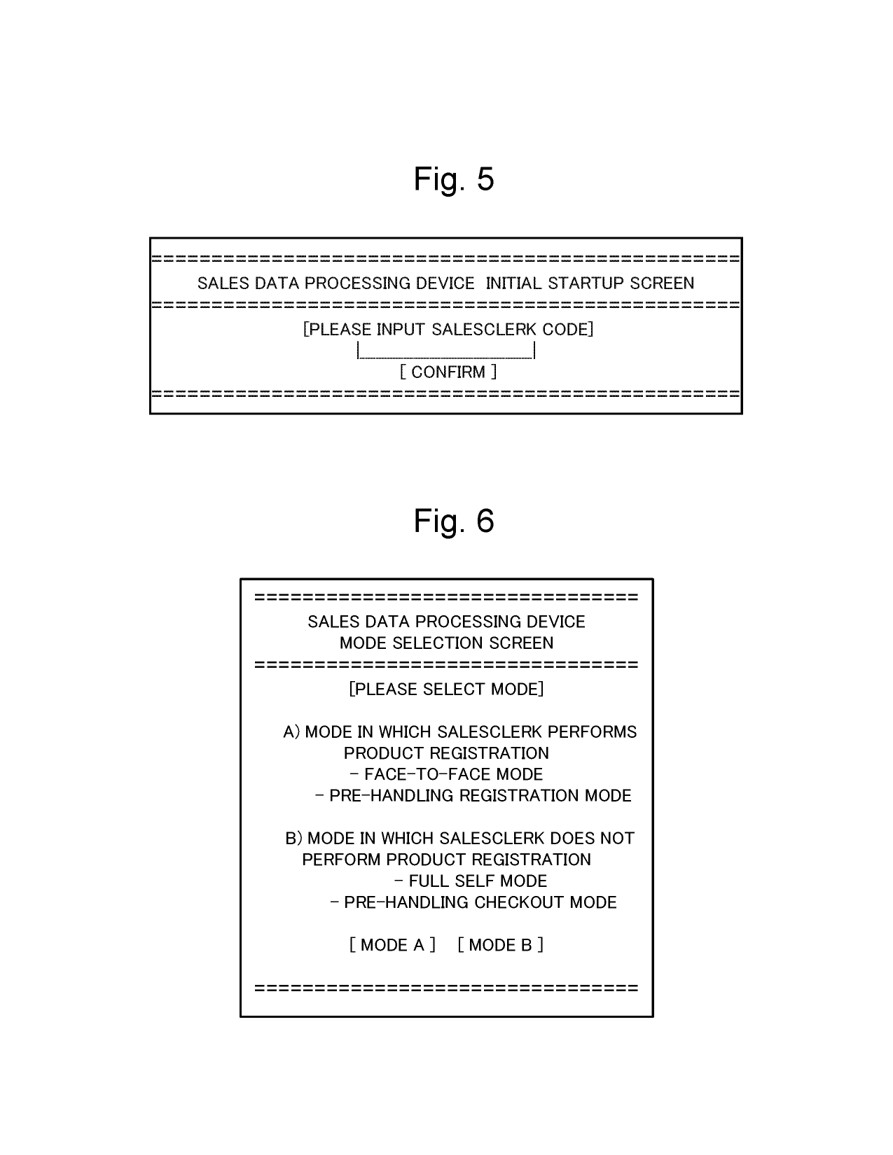

Determination of the mode is performed based on operation by the salesclerk, for example. Specifically, at the time of activation of the POS terminal 100, a screen for a salesclerk code reading standby state illustrated in FIG. 5 is displayed on the salesclerk side display 11. When the salesclerk inputs the code and is authenticated, transition is performed to a mode selection screen illustrated in FIG. 6. The salesclerk selects a mode on this screen, whereby the determination unit 104 determines the mode. Since the selection of the mode is required after an authentication process at the time of activation, a risk can be reduced that the salesclerk forgets to select the mode. This prevents operation in an unintended mode.

A “mode in which the salesclerk performs product registration” is an example of the salesclerk checkout mode, and a “mode in which the salesclerk does not perform product registration” is an example of the customer checkout mode. The salesclerk checkout mode includes a “face-to-face mode” in which settlement is performed on the POS terminal 100 and a “pre-handling registration mode” in which settlement is performed on another device. The customer checkout mode includes a “full self mode” in which the customer performs product registration on the POS terminal 100 and a “pre-handling checkout mode” in which the customer performs product registration on another device. Based on the mode selected by the salesclerk, the switching unit 105 switches the screen to be displayed next. That is, in the example of FIG. 6, when a button of “mode A” or “mode B” is pressed, transition is performed to a screen of a corresponding mode.

In a stage before selection of the mode, a message such as “Welcome! Screen in preparation. Please wait •••” may be displayed as a startup screen on the customer side display 12. Then, in response to the fact that the mode is selected, the customer side display 12 also transitions to a screen of the corresponding mode.

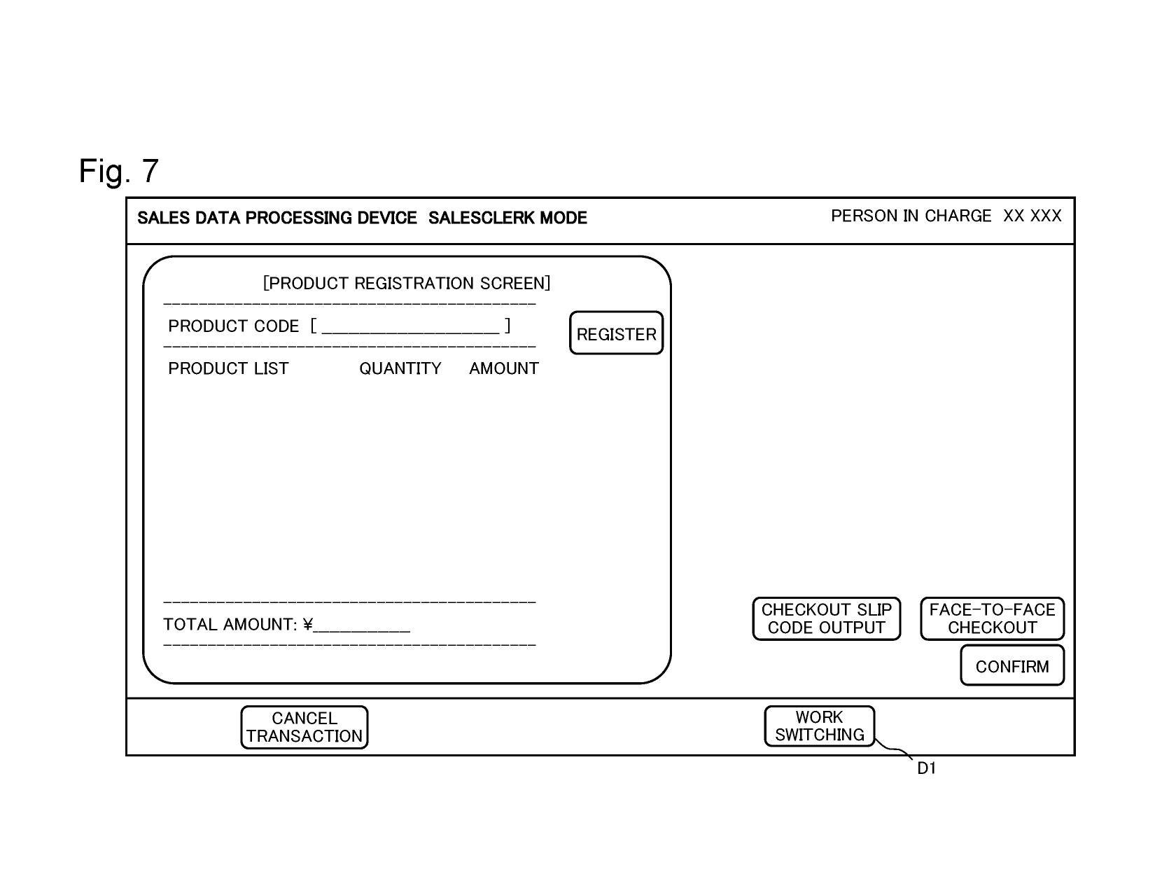

In a case where the POS terminal 100 operates in the salesclerk checkout mode, in step S3, the registration unit 101 registers a product in response to operation by the salesclerk. At this time, for example, the product registration screen illustrated in FIG. 7 is displayed on the salesclerk side display 11.

By enabling selection of the salesclerk checkout mode or the customer checkout mode at the time of activation, it is possible to efficiently use system resources. This is because necessary program modules are loaded into a memory in the determined mode at the time of activation, and unnecessary functions may be disabled. As a result, operation speed and stability of the POS terminal 100 are improved. An appropriate user interface can also be provided according to the selected mode. Furthermore, by selecting the mode at the time of activation, it is possible to easily switch store operation methods depending on the time zone and the day of the week. For example, it is possible to arrange a large number of customer checkout modes at the time of congestion, and to operate mainly in the salesclerk checkout mode at a quiet period. By the mode selection, it is possible to select an appropriate sales method according to the number of salesclerks and the expected number of customers on that day.

In step S4, the switching unit 105 performs switching between performing settlement on the POS terminal 100 and outputting the checkout information. As a result, a device on which the customer performs settlement for the registered product is switched. The switching is performed according to operation by the salesclerk or the customer. In the example of FIG. 7, by pressing of a “checkout slip code output” button, the operation is switched so that the checkout information is output. When a “face-to-face checkout” button is pressed, the operation is switched so that the settlement on the POS terminal 100 is performed. During product registration, the salesclerk can press these buttons at any timing. In FIG. 7, a selection screen may be separately displayed after a “confirm” button is pressed.

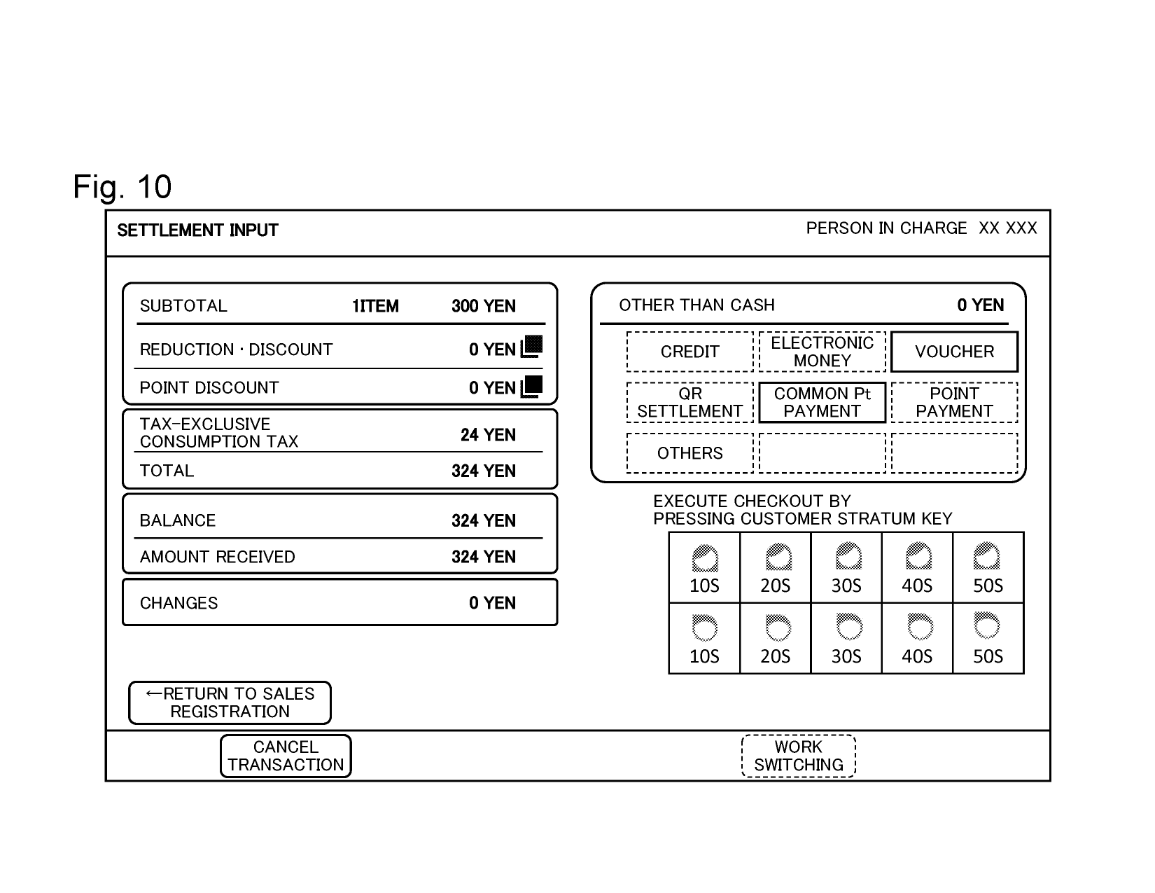

In step S5, it is determined whether the device on which the settlement is performed is the POS terminal 100 or another device. In a case where the settlement is performed on the POS terminal 100, the salesclerk checkout unit 102 performs the settlement in step S6 and processes checkout. At this time, a payment screen illustrated in FIG. 10 is displayed on the salesclerk side display 11. In a case where the settlement is performed on another device, in step S7, the salesclerk checkout unit 102 outputs the checkout information to process checkout.

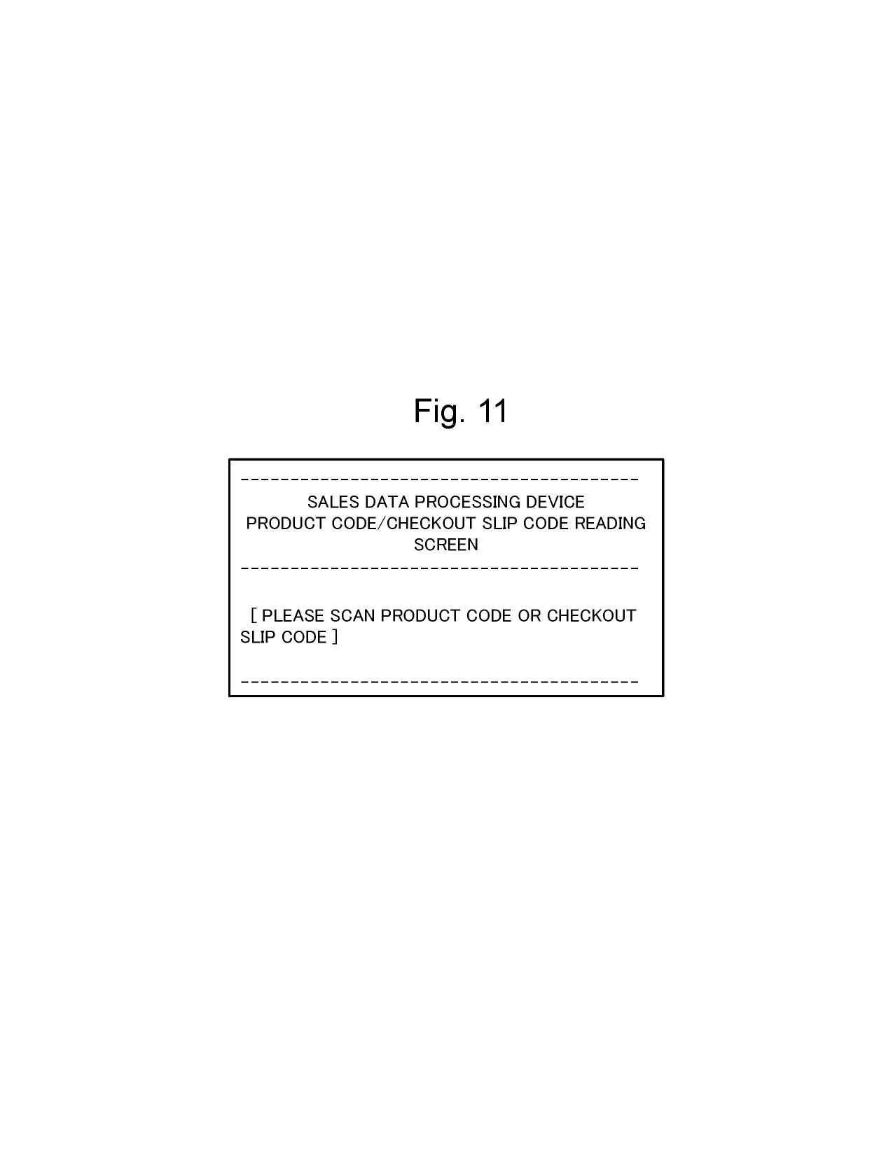

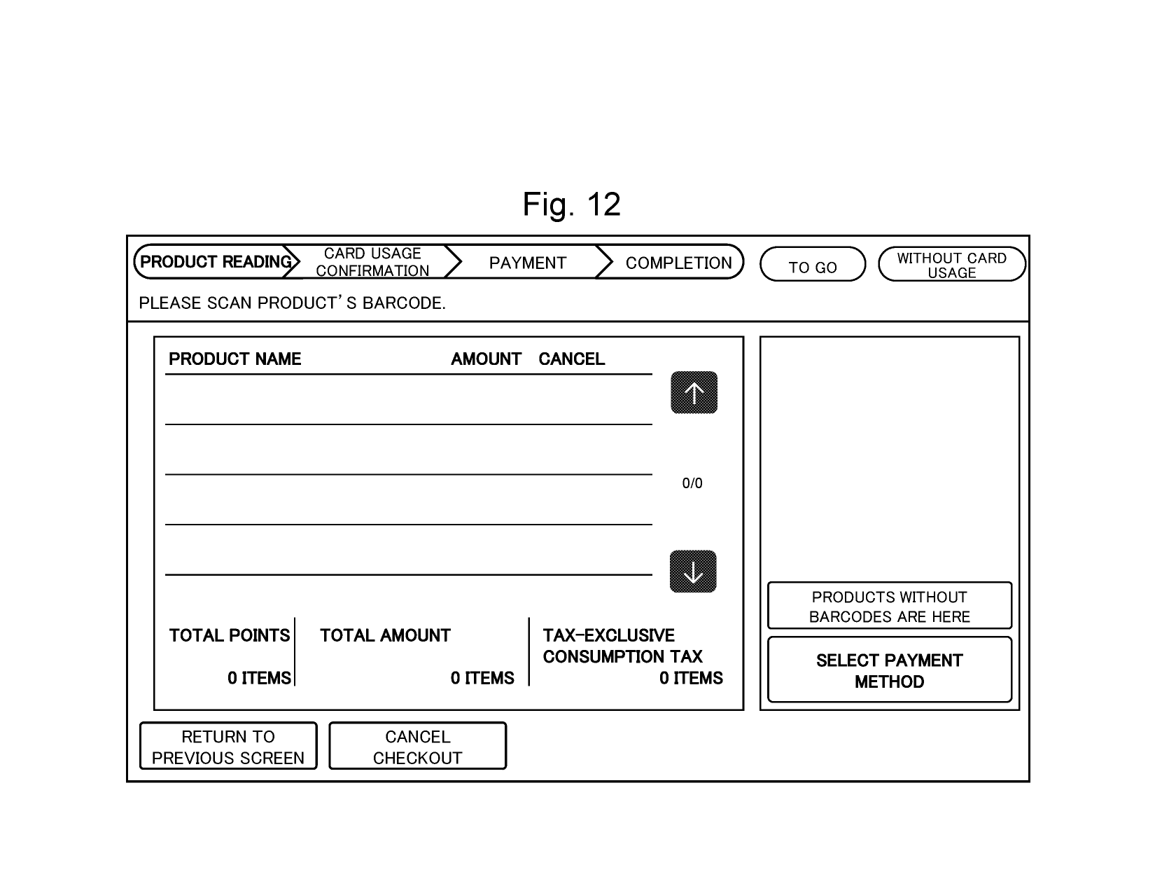

In a case where the POS terminal 100 operates in the customer checkout mode, in step S8, the registration unit 101 registers a product in response to operation by the customer. When the POS terminal 100 operates in the customer checkout mode, for example, a screen of FIG. 11 is displayed on the customer side display 12. The screen of FIG. 11 waits for reading of a product code or a checkout slip code. In a case where the product code is read, transition is performed to a screen of FIG. 12. Then, on the screen of FIG. 12, the customer registers the product.

Product registration processing in step S8 can be replaced with processing of receiving checkout information. In response to the reading of the checkout slip code, the customer checkout unit 103 may request the checkout information and receive the checkout information from the server 30. In a case where the checkout information is received, display of the product registration screen as illustrated in FIG. 12 may be omitted. Around the time of the product registration processing, the processing of receiving the checkout information may be performed.

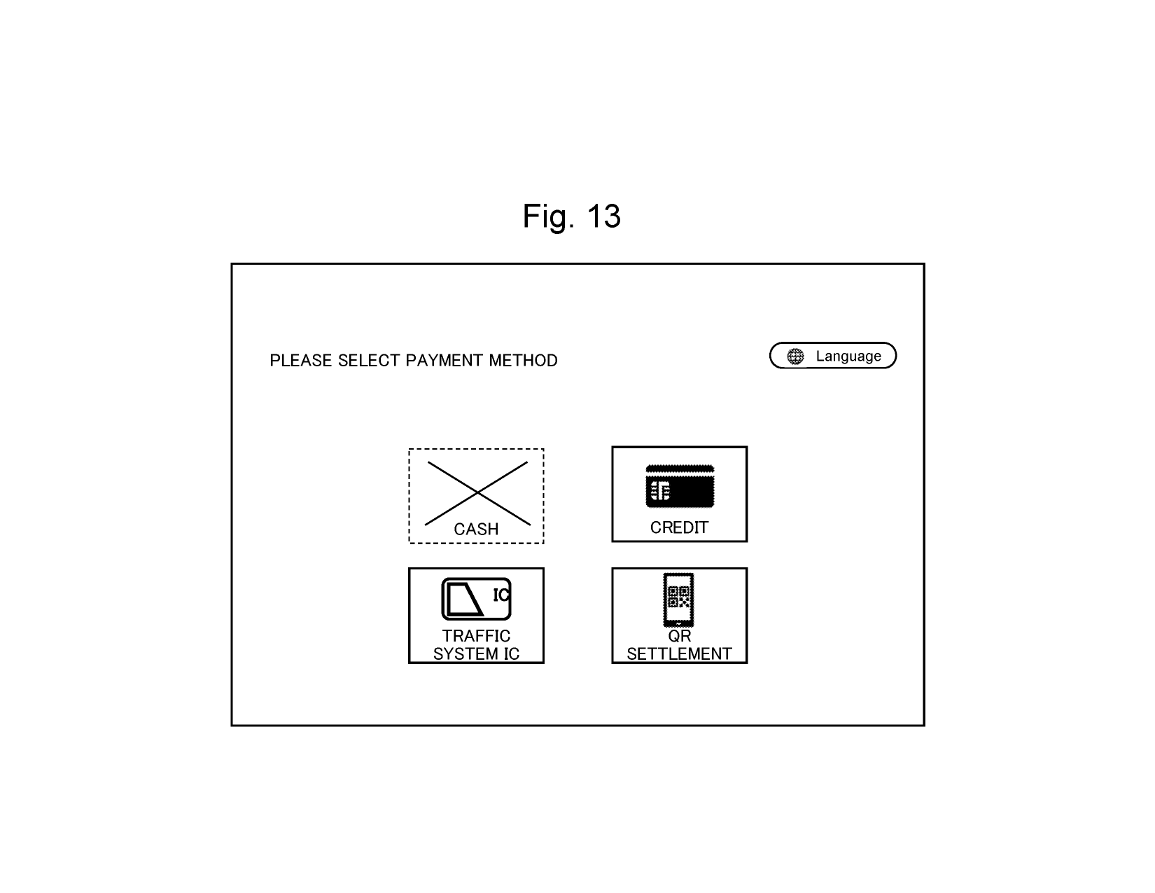

In step S9, the customer checkout unit 103 performs settlement and processes checkout. After completion of product registration, pressing a “select payment method” button in the example of FIG. 12 causes transition to a screen of FIG. 13. On the screen of FIG. 13, the customer selects a payment method and proceeds with the settlement. After completion of the settlement, a receipt is output, and a completion screen is displayed on the customer side display 12.

By execution of any one of steps S6, 7, and 9, the POS terminal 100 ends the operation of FIG. 4.

After the end of the settlement processing or after the output of the checkout information, the POS terminal 100 moves to the initial state in preparation for the next transaction. The mode determined in step S1 is maintained for the next transaction. For example, in the salesclerk checkout mode, the screen returns to the product registration screen for salesclerks. In the customer checkout mode, the screen returns to the product registration screen for customers or a standby screen for checkout information.

In step S3, the payment method selection screen may be displayed on the customer side display 12 during product registration by the salesclerk. In a case where the settlement is performed on the spot, after completion of product registration, the salesclerk checkout unit 102 performs the settlement using the selected payment method. In a case where the settlement is performed on another device, the salesclerk checkout unit 102 outputs the checkout information including information on the selected payment method.

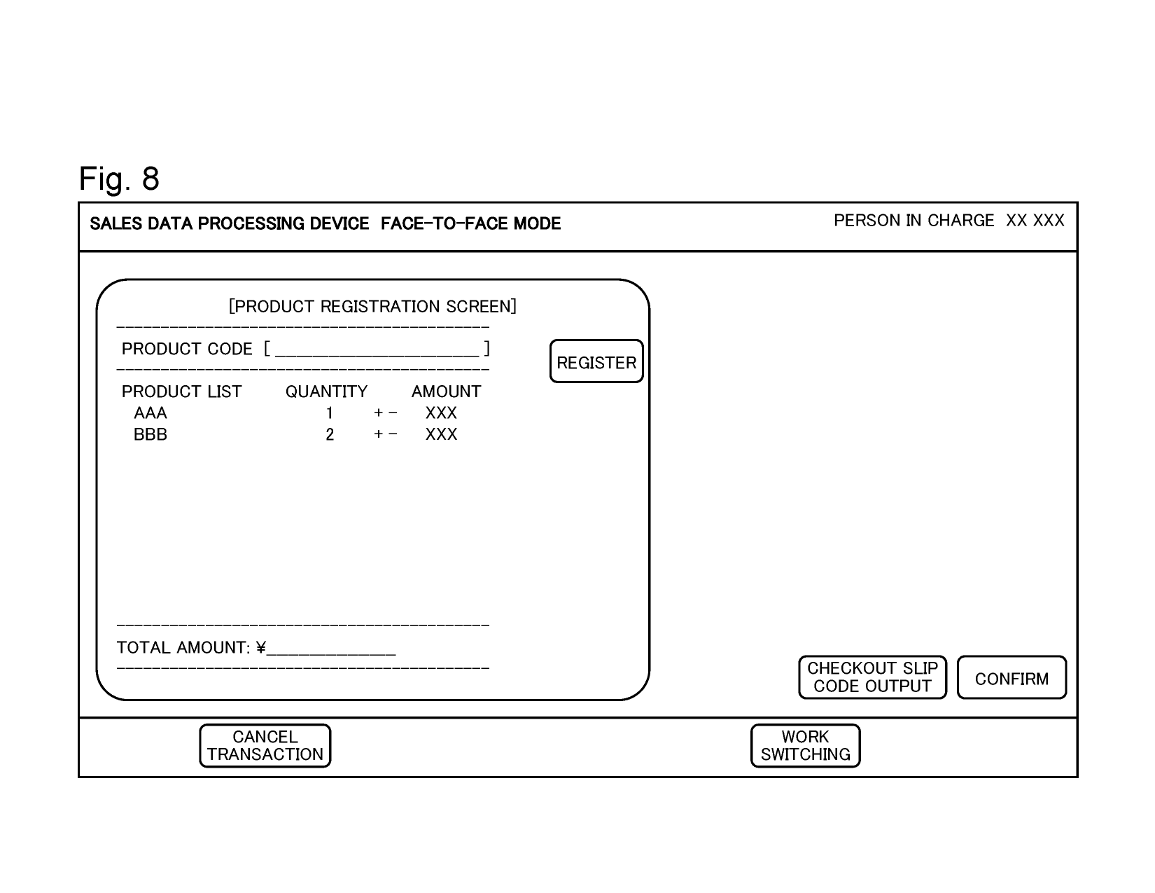

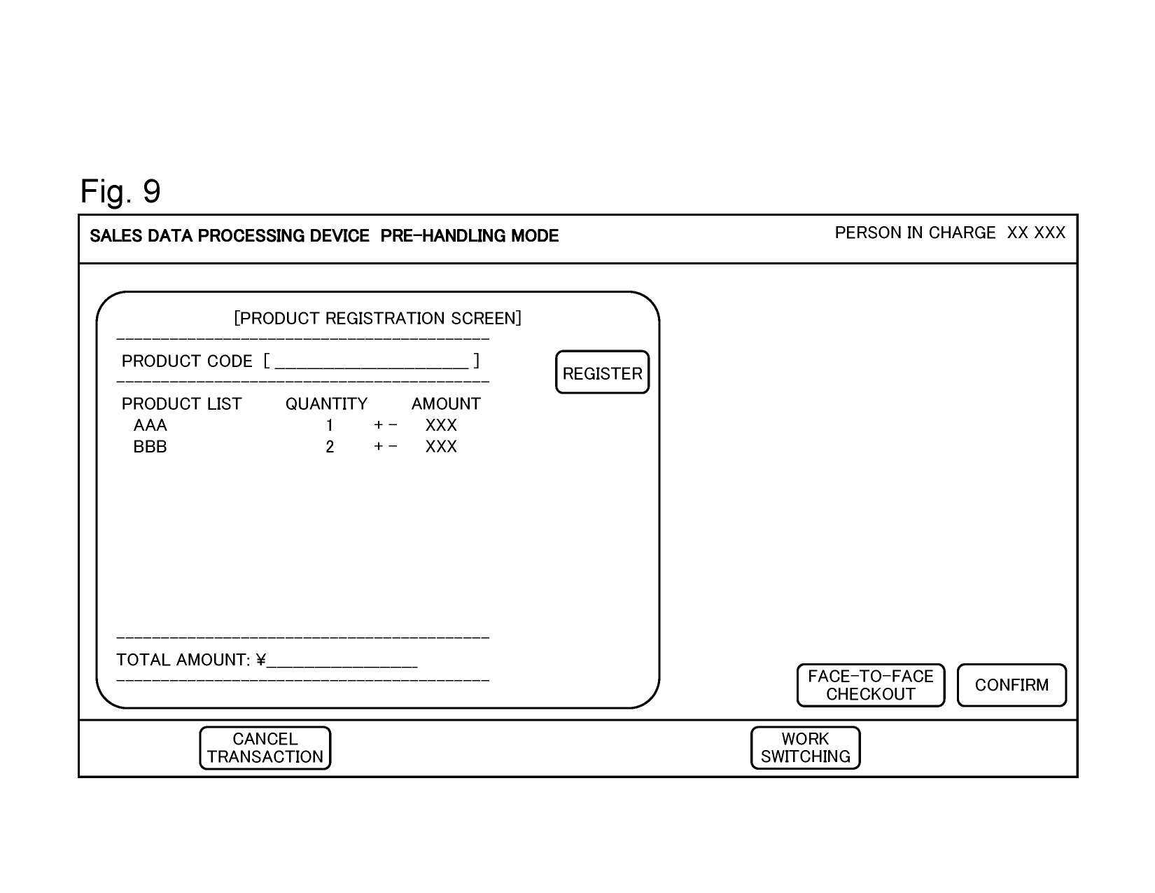

A result of switching in step S4 may be maintained for the next transaction. For example, in a case where “face-to-face checkout” is selected in FIG. 7, the product registration screen of FIG. 8 may be displayed in the next transaction. When the “confirm” button is pressed on the screen of FIG. 8, the screen of FIG. 10 is displayed, and the settlement on the POS terminal 100 is enabled. The salesclerk can press the “checkout slip code output” button at any timing during product registration. After pressing of this button, when the “confirm” button is pressed, the checkout information is output. Then, in a case where “checkout slip code output” is selected in FIG. 7, the product registration screen of FIG. 9 may be displayed in the next transaction. When the “confirm” button is pressed on the screen of FIG. 9, the checkout information is output. The salesclerk can press the “face-to-face checkout” button at any timing during product registration. When the “confirm” button is pressed after pressing of this button, the screen of FIG. 10 is displayed, and the settlement on the POS terminal 100 is enabled. As described above, when the salesclerk continuously processes transactions, pressing of another button is required only in a case where operation different from the operation continuously performed is performed, whereby switching of the settlement device is facilitated for the salesclerk.

Although the checkout slip code is issued to the customer, there is a possibility that the customer wishes to perform settlement at the checkout counter operated by the salesclerk. In this case, the salesclerk checkout unit 102 may perform settlement on the POS terminal 100 based on the read checkout slip code. For example, during the operation in the salesclerk checkout mode, the checkout slip code issued by the POS terminal 100 or another device is read on the salesclerk side in a state where a product is not yet registered in FIGS. 8 and 9. The checkout information is acquired from the server 30. Thereafter, the screen of FIG. 10 is displayed.

In the above example, a case has been described where the POS terminal 100 is configured to select a device on which settlement is performed as illustrated in FIG. 7 after activation. However, after selection of “mode A” in the example of FIG. 6, the screen of FIGS. 8 or 9 may be displayed instead of displaying the screen of FIG. 7. The selection of the settlement device by the salesclerk may be omitted by leaving of the setting at the time of the previous activation, or the like.

In the above example, an example has been described in which the salesclerk checkout mode or the customer checkout mode can be selected at the time of activation of the POS terminal 100. However, during the operation in either the salesclerk checkout mode or the customer checkout mode, the salesclerk can also select a mode. For example, as illustrated in FIG. 7, the salesclerk presses a “work switching” button D1 displayed on the salesclerk side display 11. As a result, the screen for the salesclerk code reading standby state is displayed. When the salesclerk inputs the code and is authenticated, options of work selectable by authority of the salesclerk are displayed. The options of work include, for example, work end operation, sales confirmation in the POS terminal 100, change check, and the like, in addition to the mode selection. When the salesclerk selects the mode selection work, transition is performed to the mode selection screen illustrated in FIG. 6. The salesclerk selects a mode on this screen, whereby the determination unit 104 determines the mode.

In the example of FIG. 11, a case has been described where both the product code and the checkout slip code are readable during the operation in the customer checkout mode. The switching unit 105 may display a “product code/checkout slip code selection screen” on the customer side display 12, and may perform switching of a screen to be displayed next and a code to be read, by selection of a button. For example, a “scan product code” button and a “scan checkout slip code” button are displayed together with a message “select a code to be scanned”. When the “scan product code” button is pressed, the product registration screen is displayed. When the “scan a checkout slip code” button is pressed, for example, a standby screen for the checkout slip code is displayed.

According to the example embodiment, the registration unit 101 registers a product in response to operation by the salesclerk. The salesclerk checkout unit 102 handles checkout processing in both the settlement on the POS terminal 100 and the settlement on another device. The determination unit 104 determines which of the salesclerk checkout unit 102 or the customer checkout unit 103 is to be operated. Then, in a case where the salesclerk checkout unit 102 is operated, the switching unit 105 performs switching between the settlement on the POS terminal 100 and the output of the checkout information. As described above, it is determined which of the salesclerk checkout unit 102 or the customer checkout unit 103 is to be operated, and then switching is performed between the settlement on the POS terminal 100 and the output of the checkout information, whereby it is possible to perform smooth switching. Then, it is easy for the salesclerk to understand operation switching. Therefore, according to the example embodiment, easy operation switching is enabled in a case where settlement can be performed on a device different from a device on which product registration is performed.

Furthermore, according to the example embodiment, in a case where it is determined to operate the salesclerk checkout unit 102, the switching unit 105 performs switching in response to the fact that the salesclerk has performed selection on the selection screen of the salesclerk side display 11. In this way, the salesclerk performs selection during the operation in the salesclerk checkout mode, whereby it is easy for the salesclerk to understand operation of switching. For that reason, the salesclerk can quickly and accurately perform the operation, which leads to improvement in work efficiency. A reason for this is, for example, that the salesclerk only needs to select a device on which settlement is performed, and does not need to consider the operation in the customer checkout mode in the POS terminal 100 to be operated.

According to the example embodiment, the POS terminal 100 is advantageous in that a plurality of sales methods can be handled by a single piece of hardware. This leads to reduction of capital investment and improvement of flexibility of the store layout including arrangement of furniture and negotiation space. Here, the screen and the opened function may be different for each sales method in the POS terminal 100. For example, the screen for customers in FIG. 12 is different from the screen for salesclerks in FIGS. 8 and 9 in that products cannot be deleted or added by operation on the screen. In a case where the customer purchases a plurality of identical products, the customer scans the products a plurality of times. In a case where a product is to be deleted, the customer “cancels checkout” and performs product registration again. As described above, between the salesclerk checkout mode and the customer checkout mode, in addition to the product registration screen, the operation for product registration may be different. Therefore, the determination unit 104 determines the operation in either the salesclerk checkout mode or the customer checkout mode, and the switching unit 105 performs switching, whereby efficient operation is enabled of the POS terminal 100 that executes a plurality of types of operation.

There is a case where the salesclerk registers the customer’s purchase product and settlement is performed in a device on which product registration has been performed. After completion of the product registration, the salesclerk can support the customer, such as support for settlement by the customer and bagging the product. On the other hand, there is a case where the customer performs settlement for the product registered by the salesclerk on another settlement device. After completion of the product registration, the salesclerk can perform product registration for the next customer. Therefore, a waiting time of the customer can be shortened. The POS terminal 100 according to the example embodiment is effective for, for example, a store where a line is formed depending on the time. According to the example embodiment, the POS terminal 100 operates in the salesclerk checkout mode, and switches between performing settlement on a device on which a product is registered and performing settlement on another device according to a situation of the store. Therefore, it is possible to flexibly operate the POS terminal 100 according to the situation of the store.

### Second Example Embodiment

A POS terminal 200 in the present disclosure includes a switching function according to a situation in addition to the basic configuration of a first example embodiment. With this function, it is possible to switch operation of the POS terminal 200 according to a congestion situation of a store or an operating situation of another POS terminal. A configuration is also possible by which a suitable sales method is automatically proposed and switching is performed based on the proposal. Regarding description of a second example embodiment, description will be omitted of a configuration similar to that of the first example embodiment.

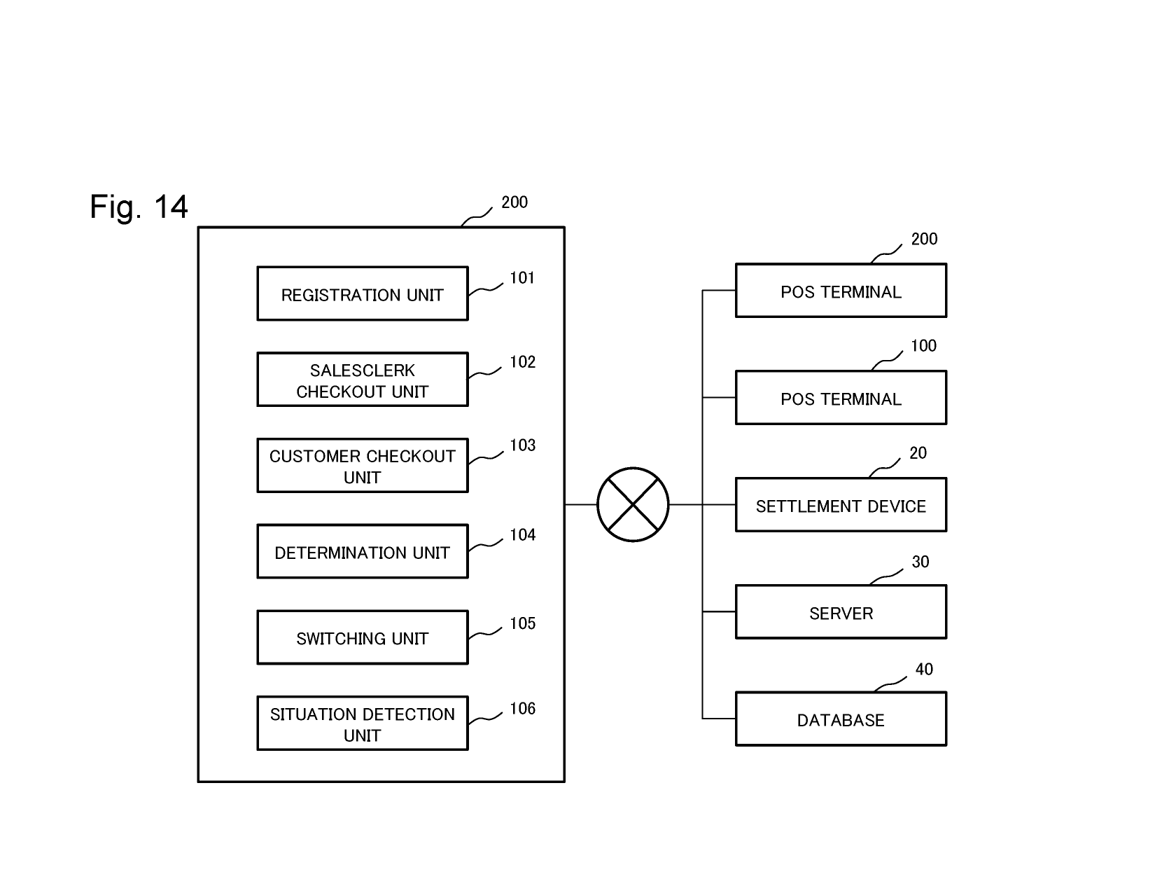

With reference to FIG. 14, a configuration example will be described of the POS terminal 200 in the present disclosure. In the POS terminal 200, a situation detection unit 106 is added to the constituent elements of the POS terminal 100 of the first example embodiment. The function of the switching unit 105 is extended.

The situation detection unit 106 detects a store situation regarding switching of the sales method in the POS terminal 200. The situation detection unit 106 detects the store situation as in any one of the following examples. The situation detection unit 106 may detect a plurality of types of store situations.

In one example, the situation detection unit 106 detects an operating situation of another device as the store situation via a network. Another device to be monitored is a device that can be used for settlement installed in the store, and is, for example, another POS terminal 200 or the POS terminal 100 of the first example embodiment. Whether another device is in use or on standby is detected as the operating situation. Whether another device is operating in the salesclerk checkout mode or operating in the customer checkout mode is detected as the operating situation. The situation detection unit 106 may perform detection by acquiring information on an operating situation of another device from the server 30. The server 30 periodically (for example, every 30 seconds) confirms a state of each of devices. Specifically, a state confirmation signal is transmitted to another device via the network, and a response is received.

In one example, the situation detection unit 106 detects the congestion situation of the store as the store situation. The congestion situation of the store can be represented by the number of people in the store or a length of a queue at a checkout counter. The situation detection unit 106 detects a customer in the store from an image captured by an in-store camera using an image recognition technology. Then, in a case where the number of customers detected exceeds a preset threshold, the situation detection unit 106 determines that the store situation is a congestion state. For example, in order to detect the length of the queue, the situation detection unit 106 estimates the length of the queue of each of checkout counters from a camera image or a processing time of the POS terminal 200. Then, the situation detection unit 106 determines that the store situation is the congestion state in a case where the estimated length of the queue exceeds a preset threshold.

The switching unit 105 analyzes data obtained from the situation detection unit 106, and determines a sales method appropriate for a current store situation. The switching unit 105 may determine the sales method based on a plurality of types of store situations detected by the situation detection unit 106. Specifically, for example, the switching unit 105 performs the following determination and switching.

An example will be described of determination based on the operating situations of other POS terminals 100 and 200. While the POS terminal 200 is operating in the salesclerk checkout mode, the switching unit 105 determines whether at least one of the other POS terminals 100 and 200 in the store is operating in the customer checkout mode. The switching unit 105 performs switching so that settlement is performed on the POS terminal 200 in a case where there are no other POS terminals 100 and 200 operating in the customer checkout mode, and checkout information is output in a case where there is a terminal operating in the customer checkout mode. The switching unit 105 may perform switching so that the checkout information is output in a case where at least one of the other POS terminals 100 and 200 operating in the customer checkout mode is on standby. Then, in a case where all the other POS terminals 100 and 200 are in use, settlement processing is executed on the POS terminal 200.

As described in the first example embodiment, there is a case where it is basically determined in advance which of the POS terminal 200 or another device performs settlement during the operation in the salesclerk checkout mode. In a case where it is basically selected to output the checkout information in order to perform settlement on another device, the switching unit 105 performs switching so that the POS terminal 200 temporarily operates depending on the operating situations of the other POS terminals 100 and 200. In a case where another device is operating in the customer checkout mode and is in a vacant state, the switching unit 105 performs switching for returning to the settlement in the another device.

The switching unit 105 may perform switching of the POS terminal 200 based on the operating situations of the grouped other POS terminals 100 and 200 next to or nearby the POS terminal 200 among a plurality of the POS terminals 100 and 200 installed in the store. Switching is automatically performed depending on the operating situations of the other POS terminals 100 and 200 next to the POS terminal 200, whereby it is possible to smoothly perform guidance on whether the customer performs checkout on the spot or performs checkout by moving sideways. As a result, a moving distance of the customer is minimized, and efficient checkout processing can be performed.

Next, an example will be described in which the switching unit 105 performs switching between performing settlement on the POS terminal 200 and outputting the checkout information according to the congestion state of the store. The switching unit 105 makes a determination based on congestion state information obtained from the situation detection unit 106. Examples of a determination criterion of the congestion state include a case where the number of customers in the store exceeds a preset threshold, a case where the length of the queue is equal to or more than a certain length, and the like. As a specific numerical example, a case where the number of customers in the store exceeds 20 or a case where the length of the queue is 3 or more is determined to be the congestion state.

Specifically, in a case where the situation detection unit 106 detects an increase in the number of customers in the store and determines that the store is congested, the switching unit 105 performs switching so that settlement is performed on the other POS terminals 100 and 200. This means switching to the pre-handling registration mode. With this switching, product registration and settlement are separated from each other, whereby it is possible to efficiently process more customers. On the other hand, in a case where the situation detection unit 106 detects a decrease in the number of customers in the store and determines that the store is in a quiet period, the switching unit 105 performs switching so that settlement is performed on the POS terminal 200. Specifically, switching is performed to the face-to-face mode. This enables more personal service to customers, which leads to improvement of customer satisfaction.

The switching unit 105 can also perform switching in stages according to the degree of the congestion state. Flexible response is possible, for example, only some POS terminals are switched to the pre-handling registration mode at the time of slight congestion and all POS terminals are switched to the pre-handling registration mode at the time of severe congestion.

Before performing switching according to the operating situation or congestion situation described above, the switching unit 105 may display a switching button on the salesclerk side display 11. The switching button may visually express the proposed sales method with an icon and a concise description. The salesclerk only taps the switching button once, whereby switching is performed to a recommended sales method according to the operating situation or the congestion situation. Rapid switching by one-touch operation enables quick response to a situation change. With the configuration in which switching is performed after selection of the switching button, it is possible to prevent switching unintended by the salesclerk.

The automatic switching by the switching unit 105 may be configured to be performed only in one direction. For example, at the time of congestion, switching is performed to the pre-handling registration mode for automatically outputting the checkout information. Then, it is possible to make switching back to the face-to-face mode after the congestion disappears be performed by operation by the salesclerk. In a case where it is detected that congestion has disappeared or in a case where a certain period of time has elapsed, the switching unit 105 may display a notification for prompting switching back on the salesclerk side display 11. The salesclerk can confirm this notification and manually perform switching back to the original mode at an appropriate timing. The automatic switching only in one direction can make the operation of the system more predictable and improve stability. It is possible to perform appropriate operation according to a situation or a policy of the store at that time by performing switching back according to the determination of the salesclerk instead of automatically performing switching back to the original situation.

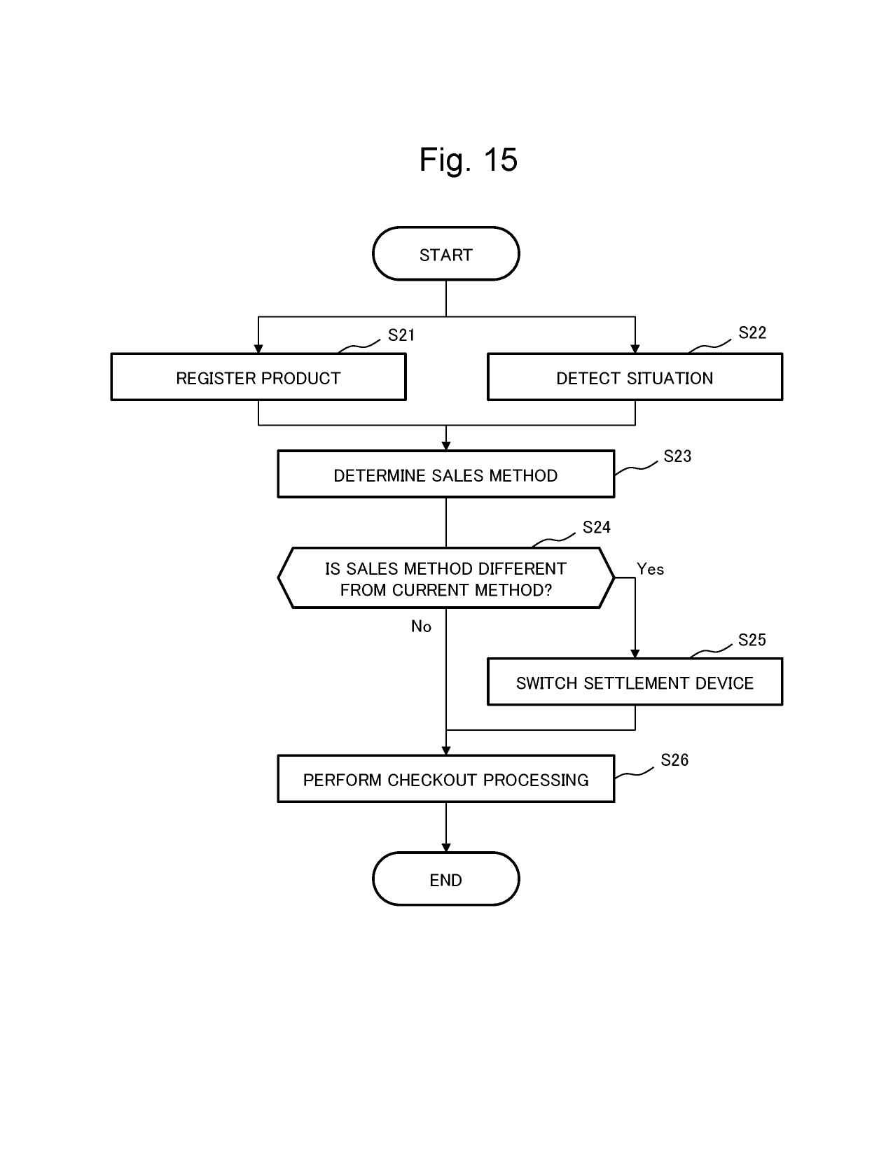

With reference to FIG. 15, an operation example will be described of the POS terminal 200. The POS terminal 200 starts the operation of FIG. 15 in a state where the salesclerk checkout mode is selected.

In step S21, the registration unit 101 registers a product by operation by the salesclerk. In step S22, the situation detection unit 106 detects a store situation. In step S23, the switching unit 105 determines an appropriate sales method. That is, it is determined whether the settlement is performed on the POS terminal 200 or another device. In step S24, the switching unit 105 determines whether the appropriate sales method is different from a current method. In a case where the appropriate sales method matches the current method (step S24: No), in step S26, the salesclerk checkout unit 102 performs checkout processing by the current method.

In a case where the appropriate sales method is different from the current method (step S24: Yes), in step S25, the switching unit 105 switches the sales method. As switching processing, a one-touch switching button may be displayed that proposes a new sales method. Then, it is determined whether the salesclerk approves the proposal. If the proposal is approved, the sales method is switched. Thereafter, in step S26, the salesclerk checkout unit 102 performs checkout processing.

Thus, the POS terminal 200 ends the operation of FIG. 15. After completion of the operation, the POS terminal 200 displays the product registration screen and the like in preparation for the next transaction.

The operation of FIG. 15 may be performed each time each transaction is started. Alternatively, the operation of FIG. 15 may be performed, for example, every certain period of time such as 30 minutes, or every certain number of transactions such as every 10 transactions. The operation may be performed when the POS terminal 200 reads the salesclerk’s identification code at the time of shift change of the salesclerk. Furthermore, the operation may be performed in a specific business hours of the store, such as immediately after opening, a peak time, or before closing. Whether to execute the operation of FIG. 15 may be controlled by the number of salesclerks. For example, in a case where the number of salesclerks is small, the automatic switching is actively performed according to the store situation, and in a case where the number of salesclerks is large, the manual switching as in the first example embodiment is sufficient.

A description will be given of an execution timing of step S23. The switching unit 105 may determine the sales method in response to the fact that a button is pressed for giving an instruction for termination of product registration. The button for giving the instruction for termination is, for example, a settlement start button on the product registration screen or the “confirm” button on the screens of FIGS. 8 and 9. By making a determination based on the store situation acquired at a timing when the button is pressed, the switching unit 105 can make a determination based on the latest store situation. The switching unit 105 may be configured to make a determination in response to the fact that one or more predetermined number of products are registered. In a case where switching is performed so that the settlement is performed on another device, if the customer is preparing for the settlement on the spot, there is a possibility that it takes time to move. For that reason, an early determination is made, whereby the customer can prepare for settlement during product registration.

After it is determined whether to perform the switching or not, a guidance screen is displayed for guiding the customer to a location where the settlement is performed. For example, in a case where the settlement is performed on the POS terminal 200, a message “settlement will be performed here” is displayed, and in a case where the settlement is performed on another device, a message “settlement will be performed at the checkout counter number **” is displayed on the customer side display 12. As a result, the customer can perform the settlement at an appropriate location without hesitation.

According to the example embodiment, the situation detection unit 106 detects the congestion situation of the store and the operating situation of another POS terminal in real time. Then, the switching unit 105 determines an appropriate sales method based on these pieces of information, and automatically performs switching as necessary. Therefore, flexible and efficient operation can be performed according to the situation of the store, and it is possible to simultaneously reduce the waiting time of the customer and improve the productivity of the store.

In the second example embodiment, the situation detection unit 106 is added to implement a function of automatically detecting the congestion situation of the store and the operating situation of another POS terminal. As a result, it is possible to automatically determine an appropriate sales method and perform switching according to the situation of the store. This function contributes to efficient customer handling particularly at the time of congestion and improvement of operation efficiency of the entire store.

### Third Example Embodiment

A description will be given of a function of the POS terminal 200 to switch the operation according to the situation in the POS terminal 200. A third example embodiment also includes a function that is particularly useful in stores that handle medicines, such as drug stores. However, application of this function is not limited to application in drug stores.

In the configuration illustrated in FIG. 14, the POS terminal 200 of the third example embodiment is different from that of the second example embodiment in the configuration of the situation detection unit 106 and the switching unit 105. In the POS terminal 200 of the third example embodiment, the description will be omitted of a configuration similar to that of the second example embodiment. A configuration of the POS terminal 200 according to the third example embodiment can also be combined with the POS terminal 100 according to the first example embodiment and the POS terminal 200 according to the second example embodiment.

While the situation detection unit 106 of the second example embodiment detects the store situation, the situation detection unit 106 of the third example embodiment monitors a state of the POS terminal 200 and detects a specific state. When detecting the specific state, the situation detection unit 106 notifies the switching unit 105 of information thereof. The specific state indicates a state in which there is a possibility of hindering normal operation of the POS terminal 200 or a state in which a special measure is required. In the following, an example will be described of the specific state detected by the situation detection unit 106.

For example, the situation detection unit 106 detects a state of a printer connected to the POS terminal 200, such as a state in which a remaining amount of receipt paper such as a thermal roll is small, out of paper, or failure of the printer. The situation detection unit 106 may detect a state of the automatic change machine, such as a shortage of change or a failure of the change machine. Furthermore, the situation detection unit 106 may detect a state of a settlement terminal, such as a failure of a card reader.

The situation detection unit 106 may monitor a code or information on a product registered in the registration unit 101 and detect that a product to be explained by a pharmacist has been registered. Specifically, the situation detection unit 106 cooperates with a product master to determine whether the registered product is a specific medicine that requires explanation by a pharmacist. Furthermore, the situation detection unit 106 can also detect registration of an age-restricted product or a product requiring special handling (examples: refrigerated goods, expensive goods).

In one example, when the POS terminal 200 is operating to perform settlement on the POS terminal 200 in the salesclerk checkout mode, the switching unit 105 performs switching of the POS terminal 200 so that the settlement is temporarily performed on another device based on notification from the situation detection unit 106. For example, switching is performed in a case where the receipt paper is near end (remaining amount is small), in a case where it is necessary to replace the receipt paper at the end (out of paper), or in a case where run out of change or shortage of change occurs. When the situation detection unit 106 detects that these problems have been solved, the switching unit 105 returns the POS terminal 200 to the original state so that settlement is performed on the POS terminal 200.

In one example, when the POS terminal 200 is operating to output the checkout information for performing the settlement on another settlement device in the salesclerk checkout mode, the switching unit 105 performs switching of the POS terminal 200 so that the settlement is temporarily performed on the POS terminal 200. For example, switching to the settlement in the face-to-face mode is performed in response to the fact that a product is registered for which explanation by a pharmacist or a registered seller is to be performed. Specific medicines require explanation by a pharmacist or a registered seller. If the customer moves to another device for checkout, it is difficult to support the customer. A pharmacist or a registered seller consistently performs product registration to checkout, whereby it is possible to smoothly support the customer. As a result, appropriate explanation and transmission of precautions regarding a specific medicine are reliably performed, which leads to improvement of customer safety and satisfaction.

In a case where only a product requiring no explanation is included, the pre-handling registration mode is maintained in which the settlement is performed on another device. As a result, it is possible to perform switching to the settlement in the face-to-face mode only in a case where it is necessary without impairing the efficiency of normal product sales.

Furthermore, the switching unit 105 may be added with a function of automatically calling an explanation staff (pharmacist or registered seller) in response to the fact that a product is registered for which explanation is to be performed. This call is performed by making a voice announcement in cooperation with an in-store announcement system or transmitting notification to a terminal carried by the explanation staff. At the time of calling, notification is also performed of information on the product, a standby location of the customer, and the like. With this function, it is possible to quickly and accurately call an appropriate explanation staff, and it is possible to minimize the waiting time of the customer and to efficiently allocate personnel. It is also possible to effectively utilize the waiting time by displaying basic information and precautions regarding the product on the customer side display 12 until the explanation staff arrives.

In a case where an age-restricted product is registered, the switching unit 105 automatically performs switching to the face-to-face mode, and displays a screen prompting age verification by the salesclerk. In the case of a product requiring special handling, the switching unit 105 displays a screen (examples: a guide of a refrigerating bag in the case of refrigerated goods, call for attention to careful handling in the case of expensive goods) prompting a response according to characteristics of the product. By taking these actions, it is possible to reliably perform legal compliance and appropriate handling of products.

According to the example embodiment, the situation detection unit 106 monitors a state of the POS terminal 200 and characteristics of the registered product, and detects a specific state or condition. The switching unit 105 dynamically performs switching to an appropriate sales method based on this detection result. Therefore, it is possible to quickly and appropriately respond to a hardware problem or sales of a product that requires a special response, and it is possible to simultaneously improve continuity of work and quality of customer service.

### Hardware Configuration

In the above-described example embodiments, the constituent elements of the POS terminals 100 and 200 represent blocks in units of functions. A part or all of the constituent elements of the POS terminals 100 and 200 may be implemented by any combination of a computer 500 and programs.

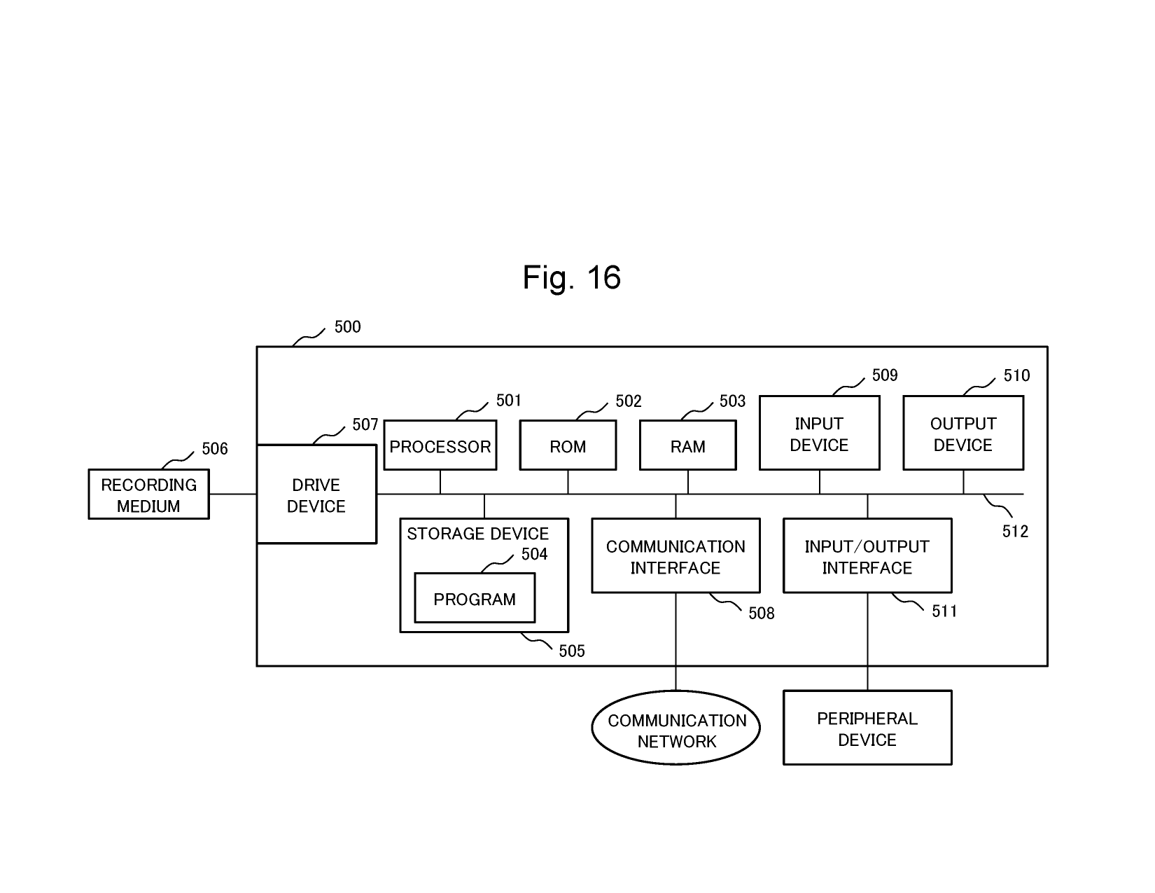

FIG. 16 is a block diagram illustrating an example of a hardware configuration of the computer 500. Referring to FIG. 16, the computer 500 includes, for example, a processor 501, a read only memory (ROM) 502, a random access memory (RAM) 503, a program 504, a storage device 505, a drive device 507, a communication interface 508, an input device 509, an output device 510, an input/output interface 511, and a bus 512.

The processor 501 controls the entire computer 500. Examples of the processor 501 include a central processing unit (CPU) and the like. The number of processors 501 is not particularly limited, and the number of processors 501 is one or more.

The program 504 includes instructions for implementing the functions of the POS terminals 100 and 200. The program 504 is stored in advance in the ROM 502, the RAM 503, and the storage device 505. The processor 501 implements the functions of the POS terminals 100 and 200 by executing the instructions included in the program 504. The RAM 503 may store data to be processed in the functions of the POS terminals 100 and 200.

The drive device 507 reads and writes a recording medium 506. The communication interface 508 provides an interface with a communication network. The input device 509 is, for example, a mouse, a keyboard, a touch panel, or the like, and receives input of information from a salesclerk, a customer, a manager, or the like. The output device 510 is, for example, a display, and outputs (displays) information to a salesclerk, a customer, a manager, and the like. The input/output interface 511 provides an interface with a peripheral device. The bus 512 connects these constituent elements of the hardware. The program 504 may be supplied to the processor 501 via the communication network, or may be stored in advance in the recording medium 506, and the drive device 507 may read the program and supply the program to the processor 501.

The hardware configuration illustrated in FIG. 16 is an example, and other constituent elements may be added or some constituent elements may not be included.

There are various modifications of methods for implementing the POS terminals 100 and 200. For example, the POS terminals 100 and 200 may be implemented by any combination of different computers and programs for each constituent element. A plurality of constituent elements included in the POS terminals 100 and 200 may be implemented by any combination of one computer and programs.

At least a part of the POS terminals 100 and 200 may be provided in a Software as a Service (SaaS) format. That is, at least a part of the functions for implementing the POS terminals 100 and 200 may be executed by software executed via a network.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. The configurations in the example embodiments can be combined with each other without departing from the scope of the present disclosure.

Some or all of the above example embodiments may be described as the following Supplementary Notes, but are not limited to the following.

### Supplementary Note 1

A sales data processing device including

a registration means for registering a product,

a salesclerk checkout means for processing checkout in response to

operation by a salesclerk, by settlement on the sales data processing

device or outputting checkout information for performing settlement on

another device, for a product registered by a salesclerk on the sales data

processing device,

a customer checkout means for processing checkout in response to

operation by a customer, by settlement on the sales data processing device

for at least one of a product registered by a customer on the sales data

processing device or a product registered by a salesclerk on another

device,

a determination means for determining to operate either the

salesclerk checkout means or the customer checkout means of the sales

data processing device, and

a switching means for performing switching between performing

settlement on the sales data processing device and outputting the checkout

information in a case where the salesclerk checkout means is operated.

### Supplementary Note 2

The sales data processing device according to Supplementary Note

1, in which

the switching means performs switching between performing

settlement on the sales data processing device and outputting the checkout

information according to operation by a salesclerk.

### Supplementary Note 3

The sales data processing device according to Supplementary Note 1 or 2, in which

the switching means performs switching between performing

settlement on the sales data processing device and outputting the checkout

information according to operation by a customer.

### Supplementary Note 4

The sales data processing device according to any one of

Supplementary Notes 1 to 3, in which

the switching means performs switching between performing

settlement on the sales data processing device and outputting the checkout

information based on an operating situation of another sales data

processing device.

### Supplementary Note 5

The sales data processing device according to any one of

Supplementary Notes 1 to 4, in which

the switching means performs switching between performing

settlement on the sales data processing device and outputting the checkout

information according to a congestion situation of a store.

### Supplementary Note 6

The sales data processing device according to any one of

Supplementary Notes 1 to 5, in which

the switching means performs switching between performing

settlement on the sales data processing device and outputting the checkout

information depending on whether the sales data processing device is in a

specific state.

### Supplementary Note 7

The sales data processing device according to any one of

Supplementary Notes 1 to 6, in which

the switching means switches guidance screens to be displayed on

a display for customers, the guidance screens respectively indicating that

settlement is performed on the sales data processing device and that the

settlement is performed on another device.

### Supplementary Note 8

The sales data processing device according to any one of

Supplementary Notes 1 to 7, in which

the switching means performs switching between displaying a

product registration screen and displaying a payment method selection

screen depending on whether a product code is read or a checkout slip

code associated with the checkout information is read.

### Supplementary Note 9

A control method including

determining to operate one of a salesclerk checkout mode and a customer checkout mode of a sales data processing device, the salesclerk checkout mode being a mode for processing checkout in response to operation by a salesclerk, by settlement on the sales data processing device or outputting checkout information for performing settlement on another device, for a product registered by a salesclerk on the sales data processing device, the customer checkout mode being a mode for processing checkout in response to operation by a customer, by settlement on the sales data processing device for at least one of a product registered by a customer on the sales data processing device or a product registered by a salesclerk on another device,

performing switching between performing settlement on the sales data processing device and outputting the checkout information in a case where the salesclerk checkout mode is operated, and

processing checkout in a mode determined.

### Supplementary Note 10

A program for causing a computer to execute

processing of determining to operate one of a salesclerk checkout mode and a customer checkout mode of a sales data processing device, the salesclerk checkout mode being a mode for processing checkout in response to operation by a salesclerk, by settlement on the sales data processing device or outputting checkout information for performing settlement on another device, for a product registered by a salesclerk on the sales data processing device, the customer checkout mode being a mode for processing checkout in response to operation by a customer, by settlement on the sales data processing device for at least one of a product registered by a customer on the sales data processing device or a product registered by a salesclerk on another device,

processing of performing switching between performing settlement on the sales data processing device and outputting the checkout information in a case where the salesclerk checkout mode is operated, and

processing checkout in a mode determined.

Some or all of the configurations described in Supplementary Notes 2 to 8 dependent on the above-described Supplementary Note 1 can also be dependent on Supplementary Notes 9 and 10 by the dependency relationship similar to that of Supplementary Notes 2 to 8. Some or all of the configurations described as the Supplementary Notes can be similarly dependent on not only the Supplementary Notes 1, 9, and 10, but also various pieces of hardware and software, and various recording devices or systems for recording software without departing from the above-described example embodiments.

1. A sales data processing device comprising:
at least one memory storing instructions; and
at least one processor configured to execute the instructions to:
determine to operate the sales data processing device in a salesclerk checkout mode or a customer checkout mode,
the salesclerk checkout mode being a mode for processing a checkout operation in response to an operation by a salesclerk for a product registered by the salesclerk on the sales data processing device, the checkout operation being processed by settlement on the sales data processing device or by outputting checkout information for performing settlement on another device, and
the customer checkout mode being a mode for processing a checkout operation in response to an operation by a customer for at least one of a product registered by the customer on the sales data processing device or a product registered by a salesclerk on another device, the checkout operation being processed by settlement on the sales data processing device;
register a product to be purchased by the customer;
configure, in a case of operating the salesclerk checkout mode, whether to perform settlement on the sales data processing device or to output the checkout information for performing settlement on another device; and
process checkout according to the mode determined and the configuration.

2. The sales data processing device according to claim 1, wherein the at least one processor is further configured to execute the instructions to:
configure whether to perform settlement on the sales data processing device or to output the checkout information according to a selection operation by a salesclerk.

3. The sales data processing device according to claim 1, wherein the at least one processor is further configured to execute the instructions to:
configure whether to perform settlement on the sales data processing device or to output the checkout information according to a selection operation by the customer.

4. The sales data processing device according to claim 1, wherein the at least one processor is further configured to execute the instructions to:
configure whether to perform settlement on the sales data processing device or to output the checkout information based on an operating situation of another sales data processing device.

5. The sales data processing device according to claim 1, wherein the at least one processor is further configured to execute the instructions to:
configure whether to perform settlement on the sales data processing device or to output the checkout information according to a congestion situation of a store.

6. The sales data processing device according to claim 1, wherein the at least one processor is further configured to execute the instructions to:
configure whether to perform settlement on the sales data processing device or to output the checkout information depending on whether the sales data processing device is in a specific state.

7. The sales data processing device according to claim 1, wherein the at least one processor is further configured to execute the instructions to:
switch guidance screens to be displayed on a display for customers, the guidance screens respectively indicating that settlement is performed on the sales data processing device and that the settlement is performed on another device.

8. The sales data processing device according to claim 1, wherein the at least one processor is further configured to execute the instructions to:
switch between displaying a product registration screen and displaying a payment method selection screen depending on whether a product code is read or a checkout slip code associated with the checkout information is read.

9. A control method comprising:
determining to operate a sales data processing device in a salesclerk checkout mode or a customer checkout mode,
the salesclerk checkout mode being a mode for processing a checkout operation in response to an operation by a salesclerk for a product registered by the salesclerk on the sales data processing device, the checkout operation being processed by settlement on the sales data processing device or by outputting checkout information for performing settlement on another device, and
the customer checkout mode being a mode for processing a checkout operation in response to an operation by a customer for at least one of a product registered by the customer on the sales data processing device or a product registered by a salesclerk on another device, the checkout operation being processed by settlement on the sales data processing device;
configuring, in a case of operating the salesclerk checkout mode, whether to perform settlement on the sales data processing device or to output the checkout information for performing settlement on another device; and
processing checkout according to the mode determined and the configuration.

10. A non-transitory computer-readable recording medium storing a program for causing a computer to execute processing comprising:
determining to operate a sales data processing device in a salesclerk checkout mode or a customer checkout mode,
the salesclerk checkout mode being a mode for processing a checkout operation in response to an operation by a salesclerk for a product registered by the salesclerk on the sales data processing device, the checkout operation being processed by settlement on the sales data processing device or by outputting checkout information for performing settlement on another device, and
the customer checkout mode being a mode for processing a checkout operation in response to an operation by a customer for at least one of a product registered by the customer on the sales data processing device or a product registered by a salesclerk on another device, the checkout operation being processed by settlement on the sales data processing device;
configuring, in a case of operating the salesclerk checkout mode, whether to perform settlement on the sales data processing device or to output the checkout information for performing settlement on another device; and
processing checkout according to the mode determined and the configuration.

11. The sales data processing device according to claim 4, wherein the at least one processor is further configured to execute the instructions to:
configure to perform settlement on the sales data processing device in a case where the another sales data processing device is operating in the salesclerk checkout mode or in a case where the another sales data processing device is operating in the customer checkout mode but is in use by another customer; and
configure to output the checkout information in a case where the another sales data processing device is operating in the customer checkout mode and is not in use by another customer.

12. The sales data processing device according to claim 5, wherein the at least one processor is further configured to execute the instructions to:
configure to perform settlement on the sales data processing device in a case where the congestion situation indicates that the store is not congested; and
configure to output the checkout information in a case where the congestion situation indicates that the store is congested.

13. The sales data processing device according to claim 6, wherein the at least one processor is further configured to execute the instructions to:
configure to output the checkout information in a case where the sales data processing device is in the specific state including at least one of a receipt paper shortage, a printer malfunction, a change shortage, or a payment terminal malfunction.

14. The sales data processing device according to claim 6, wherein the at least one processor is further configured to execute the instructions to:
configure to perform settlement on the sales data processing device in a case where the sales data processing device is in the specific state including registration of a product requiring explanation by a pharmacist or registered seller.

15. The sales data processing device according to claim 1, wherein the at least one processor is further configured to execute the instructions to:
determine to operate the sales data processing device in the salesclerk checkout mode or the customer checkout mode based on a selection operation by a salesclerk on a mode selection screen.

16. The sales data processing device according to claim 1, wherein the at least one processor is further configured to execute the instructions to:
determine to operate the sales data processing device in the salesclerk checkout mode when a human sensor detects a person on a salesclerk side of the sales data processing device; and
determine to operate the sales data processing device in the customer checkout mode when the human sensor does not detect a person on the salesclerk side of the sales data processing device.

17. The sales data processing device according to claim 1, wherein the at least one processor is further configured to execute the instructions to:
determine to operate the sales data processing device in the salesclerk checkout mode when a display screen is oriented toward a salesclerk side; and
determine to operate the sales data processing device in the customer checkout mode when the display screen is oriented toward a customer side.
